(19) United States
(12) Patent Application Publication
(10) Pub. No.: US 2026/0012769 A1
(43) Pub. Date: Jan. 8, 2026

(54) ELECTRONIC DEVICE FOR CONTROLLING BLUETOOTH CONNECTION AND OPERATION METHOD THEREOF

(71) Applicant: Samsung Electronics Co., Ltd., Suwon-si (KR)

(72) Inventors: Jaehyeok LEE, Suwon-si (KR); Jaehoon LEE, Suwon-si (KR)

(21) Appl. No.: 19/323,522

(22) Filed: Sep. 9, 2025

Related U.S. Application Data
(63) Continuation of application No. PCT/KR2024/001326, filed on Jan. 29, 2024.

(30) Foreign Application Priority Data
Apr. 14, 2023 (KR) 10-2023-0049339
Mar. 15, 2023 (KR) 10-2023-0033714

(51) Int. Cl. H04W 4/80; H04W 56/00; H04W 76/15

(52) U.S. Cl. CPC H04W 4/80; H04W 56/002; H04W 76/15

(57) ABSTRACT

An electronic device is provided. The electronic device includes memory, including one or more storage media, storing instructions, a wireless communication circuitry configured to support Bluetooth (BT) communication, and one or more processors communicatively coupled to the memory and the wireless communication circuitry, wherein the instructions, when executed by the one or more processors individually or collectively, cause the electronic device to receive advertising data from an external electronic device through the wireless communication circuitry, determine whether the advertising data includes predetermined information, based on the advertising data comprising the predetermined information, establish a first data connection with the external electronic device through the wireless communication circuitry, the first data connection being designated not to perform a data synchronization operation, receive a message requesting connection switching related to a state change of the external electronic device from the external electronic device while the first data connection is maintained, based on the reception of the message, establish a second data connection with the external electronic device through the wireless communication circuitry, the second data connection being designated to perform a data synchronization operation, and perform data synchronization related to one or more applications associated with the external electronic device through the second data connection.

### CROSS-REFERENCE TO RELATED APPLICAIONS(S)

This application is a continuation application, claiming priority under 35 U.S.C. § 365(c), of an International application No. PCT/KR2024/001326, filed on January 29, 2024, which is based on and claims the benefit of a Korean patent application number 10-2023-0033714, filed on March 15, 2023, in the Korean Intellectual Property Office, and of a Korean patent application number 10-2023- 0049339, filed on April 14, 2023, in the Korean Intellectual Property Office, the disclosure of each of which is incorporated by reference herein in its entirety.

### BACKGROUND

### Field

The disclosure relates to an electronic device for controlling a Bluetooth (BT) connection and a method of operating the same.

### Description of Related Art

With the development of communication technology, wearable electronic devices (for example, wearable devices) are becoming small and light enough to be used without much inconvenience even if worn on the user's body. For example, wearable devices such as a head mounting display device (HMD), a smart watch (or band), a contact lens-type device, a ring-type device, a wallet-type device, a shoe-type device, or a clothing-type device have been commercialized. The wearable device is directly worn on the body, thereby improving portability and user accessibility.

The wearable device that can be worn on the user's body may provide various functions. The wearable device may satisfy various requirements of the user by providing the user with improved functions of achieving synergy through interworking with a main electronic device having various functions, for example, a mobile communication user terminal. For example, the wearable device may include a heart rate sensor, a body temperature measurement sensor, a pulse measurement sensor, a sound wave sensor, and/or an acceleration sensor to collect various biometric information (for example, a heart rate, a pulse rate, body temperature, or pulse) and/or health information (momentum) of the user. Further, the wearable device may provide a health management function to the user by transmitting the collected biometric information and/or health information to the main electronic device.

Some of application functions installed in the main electronic device may be provided to the user through the wearable device. For example, when the mobile communication user terminal receives mail, messages, or calls, a notification related thereto may be output through the wearable device (for example, through a display, sound output, and/or vibration).

Such interworking functions may be provided in the state where the wearable device and the main electronic device are connected through wireless communication, and thus the wearable device may consume more power when the interworking function is executed compared to the case where a function independently executed in the wearable device is executed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method of operating the same for controlling a Bluetooth connection according to a state of an external electronic device.

Another aspect of the disclosure is to provide an electronic device and a method of operating the same for limiting data synchronization through the Bluetooth connection when the external electronic device is in a predetermined state.

Additional aspects will be set forth in part in the description which follows and, in part, will be apparent from the description, or may be learned by practice of the presented embodiments.

In accordance with an aspect of the disclosure, an electronic device is provided. The electronic device includes memory, including one or more storage media, storing instructions, a wireless communication module configured to support Bluetooth (BT) communication, and one or more processors communicatively coupled to the memory and the wireless communication module, wherein the instructions, when executed by the one or more processors individually or collectively, cause the electronic device to receive advertising data from an external electronic device through the wireless communication module, determine whether the advertising data includes predetermined information, based on the advertising data including the predetermined information, establish a first data connection with the external electronic device through the wireless communication module, the first data connection being designated not to perform a data synchronization operation, receive a message requesting connection switching related to a state change of the external electronic device from the external electronic device while the first data connection is maintained, based on the reception of the message, establish a second data connection with the external electronic device through the wireless communication module, the second data connection being designated to perform a data synchronization operation, and perform data synchronization related to one or more applications associated with the external electronic device through the second data connection.

In accordance with another aspect of the disclosure, an electronic device is provided. The electronic device includes memory, including one or more storage media, storing instructions, a wireless communication module configured to support Bluetooth (BT) communication, and one or more processors communicatively coupled to the memory and the wireless communication module, wherein the instructions, when executed by the one or more processors individually or collectively, cause the electronic device to receive advertising data from an external electronic device through the wireless communication module, based on the reception of the advertising data, establish a first data connection with the external electronic device through the wireless communication module, the first data connection being designated not to perform a data synchronization operation, receive a message requesting connection switching related to a state change of the external electronic device from the external electronic device while the first data connection is maintained, based on the reception of the message, establish a second data connection with the external electronic device through the wireless communication module, the second data connection being designated to perform a data synchronization operation, and perform data synchronization related to one or more applications associated with the external electronic device through the second data connection.

In accordance with another aspect of the disclosure, an electronic device is provided. The electronic device includes memory, including one or more storage media, storing instructions, a wireless communication module configured to support Bluetooth (BT) communication, and one or more processors communicatively coupled to the memory and the wireless communication module, wherein the instructions, when executed by the one or more processors individually or collectively, cause the electronic device to receive advertising data from an external electronic device through the wireless communication module, determine whether the advertising data includes predetermined information, based on identifying that the advertising data includes the predetermined information, determine whether a first received signal strength measured for the external electronic device exceed a first threshold value, in case that the first received signal strength exceeds the first threshold value, determine that the external electronic device is discovered, based on identifying that the advertising data does not include the predetermined information, determine whether a second received signal strength measured for the external electronic device exceeds a second threshold value smaller than the first threshold value, and in case that the second received signal strength exceeds the second threshold value, determine that the external electronic device is discovered.

In accordance with another aspect of the disclosure, an electronic device for controlling a Bluetooth (BT) connection is provided. The electronic device includes memory, comprising one or more storage media, storing instructions, a sensor module, a communication circuit configured to support Bluetooth communication, and one or more processors communicatively coupled to the memory, the sensor module, and the communication circuit, wherein the instructions, when executed by the one or more processors individually or collectively, cause the electronic device to determine, through the sensor module, whether the electronic device is in a predetermined state, in case that the electronic device is in the predetermined state, broadcast advertising data including predetermined information, establish a first data connection with the external electronic device receiving the advertising data through the communication circuit, the first data connection being designated not to perform the data synchronization operation, detect a state change of the electronic device while the first data connection is maintained, based on detecting the state change, transmit a message requesting connection switching to the external electronic device, based on the transmission of the message, establish a second data connection with the external electronic device through the communication circuit, the second data connection being designated to perform a data synchronization operation, and perform data synchronization related to one or more applications associated with the external electronic device through the second data connection.

In accordance with another aspect of the disclosure, an electronic device for controlling a Bluetooth (BT) connection is provided. The electronic device includes memory, including one or more storage media, storing instructions, a sensor module, a communication circuit configured to support Bluetooth communication, and one or more processors communicatively coupled to the memory, the sensor module, and the communication circuit, wherein the instructions, when executed by the one or more processors individually or collectively, cause the electronic device to broadcast advertising data through the communication circuit, establish a first data connection with the external electronic device receiving the advertising data through the communication circuit, the first data connection being designated not to perform a data synchronization operation, detect a state change of the electronic device while the first data connection is maintained, based on detecting the state change, transmit a message requesting connection switching to the external electronic device, based on the transmission of the message, establish a second data connection with the external electronic device through the communication circuit, the second data connection being designated to perform a data synchronization operation, and perform data synchronization related to one or more applications associated with the external electronic device through the second data connection.

In accordance with another aspect of the disclosure, an operation method of an electronic device for controlling a Bluetooth connection is provided. The operation method includes an operation of receiving advertising data from an external electronic device. The method includes an operation of determining whether the advertising data includes predetermined information. The method includes an operation of establishing a first data connection with the external electronic device, based on the advertising data including the predetermined information, the first data connection being designated not to perform a data synchronization operation. The method includes an operation of receiving a message requesting connection switching related to a state change of the external electronic device from the external electronic device while the first data connection is maintained. The method includes an operation of establishing a second data connection with the external electronic device, based on the reception of the message, the second data connection being designated to perform a data synchronization operation. The method includes an operation of performing data synchronization related to one or more applications associated with the external electronic device through the second data connection.

In accordance with another aspect of the disclosure, a method of an electronic device for controlling a Bluetooth connection is provided. The method includes an operation of determining whether the electronic device is in a predetermined state through a sensor module. The method includes an operation of transmitting advertising data including predetermined information when the electronic device is in the predetermined state. The method includes an operation of establishing a first data connection with the external electronic device receiving the advertising data, the first data connection being designated not to perform a data synchronization operation. The method includes an operation of detecting a state change of the electronic device while the first data connection is maintained. The method includes an operation of transmitting a connection switching request message to the external electronic device, based on detecting the state change. The method includes an operation of establishing a second data connection with the external electronic device, based on the transmission of the connection switching request message, the second data connection being designated to perform a data synchronization operation. The method includes an operation of performing data synchronization related to one or more applications associated with the external electronic device through the second data connection.

In accordance with another aspect of the disclosure, one or more non- transitory computer-readable storage media storing one or more computer programs including computer-executable instructions that, when executed by one or more processors of an electronic device individually or collectively, cause the electronic device to perform operations are provided. The operations include receiving advertising data from an external electronic device through a wireless communication module, determining whether the advertising data includes predetermined information, based on the advertising data including the predetermined information, establishing a first data connection with the external electronic device through the wireless communication module, , the first data connection being designated not to perform a data synchronization operation, receiving a message requesting connection switching related to a state change of the external electronic device from the external electronic device while the first data connection is maintained, based on the reception of the message establishing a second data connection with the external electronic device through the wireless communication module, the second data connection being designated to perform a data synchronization operation, and performing data synchronization related to one or more applications associated with the external electronic device through the second data connection.

In accordance with another aspect of the disclosure, one or more non- transitory computer-readable storage media storing one or more computer programs including computer-executable instructions that, when executed by one or more processors of an electronic device individually or collectively, cause the electronic device to perform operations are provided. The operations include receiving advertising data from an external electronic, establishing a first data connection with the external electronic device, based on the reception of the advertising data, the first data connection being designated not to perform a data synchronization operation, receiving a message requesting connection switching related to a state change of the external electronic device from the external electronic device while the first data connection is maintained, establishing a second data connection with the external electronic device, based on the reception of the message, the second data connection being designated to perform the data synchronization operation, and performing data synchronization related to one or more applications associated with the external electronic device through the second data connection.

In accordance with another aspect of the disclosure, one or more non- transitory computer-readable storage media storing one or more computer programs including computer-executable instructions that, when executed by one or more processors of an electronic device individually or collectively, cause the electronic device to perform operations are provided. The operations include receiving advertising data from an external electronic device, determining whether the advertising data includes predetermined information, determining whether a first received signal strength measured for the external electronic device exceed a first threshold value, based on identifying that the advertising data includes the information, determining that the external electronic device is discovered when the first received signal strength exceeds the first threshold value, determining whether a second received signal strength measured for the external electronic device exceeds a second threshold value smaller than the first threshold value, based on identifying that the advertising data does not include the information, and determining that the external electronic device is discovered when the second received signal strength exceeds the second threshold value.

In accordance with another aspect of the disclosure, one or more non- transitory computer-readable storage media storing one or more computer programs including computer-executable instructions that, when executed by one or more processors of an electronic device individually or collectively, cause the electronic device to perform operations are provided. The operations include determining whether the electronic device is in a predetermined state through a sensor module, transmitting advertising data including predetermined information when the electronic device is in the predetermined state, establishing a first data connection with an external electronic device receiving the advertising data, the first data connection being designated not to perform a data synchronization operation, detect a state change of the electronic device while the first data connection is maintained, transmitting a connection switching request message to the external electronic device, based on the detecting the state change, establishing a second data connection with the external electronic device, based on the transmission of the connection switching request message, the second data connection being designated to perform a data synchronization operation, and performing data synchronization related to one or more applications associated with the external electronic device through the second data connection.

In accordance with another aspect of the disclosure, one or more non- transitory computer-readable storage media storing one or more computer programs including computer-executable instructions that, when executed by one or more processors of an electronic device individually or collectively, cause the electronic device to perform operations are provided. The operations include broadcasting advertising data, establishing a first data connection with an external electronic device receiving the advertising data, the first data connection being designated not to perform a data synchronization operation, detecting a state change of the electronic device while the first data connection is maintained, transmitting, to the external electronic device, a message requesting connection switching, based on detecting the state change, establish a second data connection with the external electronic device, based on the transmission of the message, the second data connection being designated to perform a data synchronization operation, and performing data synchronization related to one or more applications associated with the external electronic device through the second data connection.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 is a diagram illustrating a connection of a wearable device according to an embodiment of the disclosure;

FIG. 3 is a block diagram illustrating a configuration of an external electronic device according to an embodiment of the disclosure;

FIG. 4 is a diagram illustrating data synchronization through the Bluetooth connection according to an embodiment of the disclosure;

FIGS. 5A and 5B are diagrams illustrating the disconnection and the connection of Bluetooth communication according to various embodiments of the disclosure;

FIG. 6 is a sequence diagram illustrating the data connection and data synchronization according to an embodiment of the disclosure;

FIG. 7A is a diagram illustrating the Bluetooth connection that does not include data synchronization according to an embodiment of the disclosure;

FIG. 7B is a diagram illustrating the Bluetooth connection including data synchronization according to an embodiment of the disclosure;

FIG. 8 is a flowchart illustrating a procedure of the electronic device controlling the Bluetooth connection, based on advertising data, according to an embodiment of the disclosure;

FIG. 9 is a flowchart illustrating a procedure of the external electronic device transmitting advertising data for controlling the Bluetooth connection according to an embodiment of the disclosure;

FIGS. 10A and 10B are diagrams illustrating formats of advertising data including information that controls a data connection according to various embodiments of the disclosure;

FIG. 11 is a sequence diagram illustrating a procedure of controlling the Bluetooth connection, based on advertising data, according to an embodiment of the disclosure;

FIG. 12 is a flowchart illustrating a procedure of the electronic device that controls the Bluetooth connection according to an embodiment of the disclosure;

FIG. 13 is a flowchart illustrating a procedure of the external electronic device that controls the Bluetooth connection in a non-wearing state according to an embodiment of the disclosure;

FIG. 14 is a sequence diagram illustrating a procedure of controlling the Bluetooth connection in the non-wearing state according to an embodiment of the disclosure;

FIG. 15 is a diagram illustrating an operation of limiting the Bluetooth connection for the external electronic device in the non-wearing state according to an embodiment of the disclosure;

FIG. 16 is a flowchart illustrating a procedure of the electronic device controlling the Bluetooth connection, based on advertising data, according to an embodiment of the disclosure; and

FIG. 17 is a sequence diagram illustrating a procedure of controlling the Bluetooth connection, based on advertising data, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well- known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms "a," "an," and "the" include plural referents unless the context clearly dictates otherwise. Thus, for example, reference to "a component surface" includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth* chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

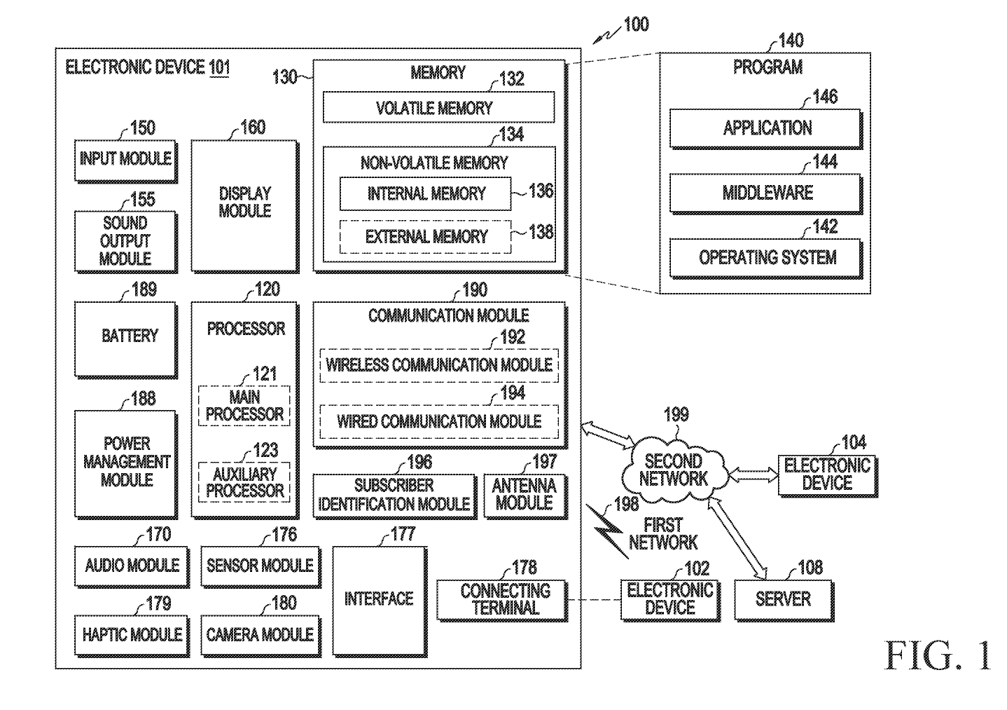

FIG. 1 is a block diagram illustrating an electronic device 101 in a network environment 100 according to an embodiment of the disclosure.

Referring to FIG. 1 , the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM} wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra- reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high- frequency band, such as, e.g., beamforming, massive multiple-input and multiple- output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter- peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

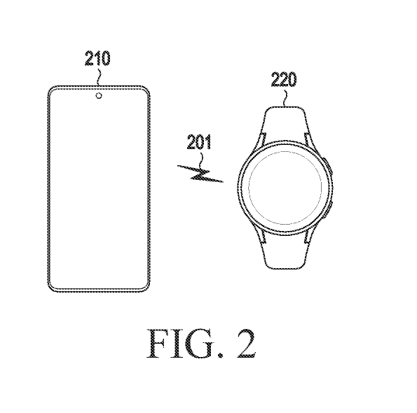

FIG. 2 is a diagram illustrating a connection of a wearable device according to an embodiment of the disclosure.

Referring to FIG. 2, an electronic device 210 (for example, the electronic device 101) may provide a function interworked with an external electronic device 220 by transmitting and receiving data to and from the external electronic device 220 (for example, the electronic device 102) through wireless communication 201. For example, the electronic device 210 may include at least one of a smartphone, a tablet personal computer (PC), a mobile phone, a video phone, an e-book reader, a desktop personal computer (PC), a laptop personal computer (PC), a netbook computer, a personal digital assistant (PDA), a portable multimedia player (PMP), an mpeg-1 audio layer 3 (MP3) player, or a mobile medical device. The external electronic device 220 may be a wearable device having a structure that can be worn on the user's body and may include, for example, at least one of an HMD such as electronic glasses, electronic clothing, an electronic bracelet, an electronic necklace, electronic appcessory, an electronic tattoo, or a smartwatch.

In an embodiment, the electronic device 210 may include a portable mobile communication device such as a smartphone, and the external electronic device 220 may include a device having a structure of a wristwatch. The electronic device 210 and the external electronic device 220 may transmit and receive data according to at least one communication scheme among various short-range wireless communication technologies, for example, Wi-Fi, Bluetooth (for example, Bluetooth classic, Bluetooth legacy, or Bluetooth low energy (BLE)), Zigbee, an ultra-wideband (USB), a wireless sensor network, or near field communication (NFC). In an embodiment, the electronic device 210 and the external electronic device 220 may be configured to communicate through cellular mobile communication technology (for example, 3rd generation partnership project (3GPP), long-term evolution (LTE), LTE advanced (LTE-A), 5G, or new radio (NR).

According to transmission and reception of data between the electronic device 210 and the external electronic device 220, the electronic device 210 and the external electronic device 220 may interwork with each other through the wireless communication 201 and use synchronized data. In the disclosure, a function that can be provided through interworking between the electronic device 210 and the external electronic device 220 may be referred to as an interworking function. The interworking function may include, for example, applications of the same type included (for example, stored, installed, or executed) in the electronic device 210 and the external electronic device 220. The interworking function may include one or more functions, for example, a call, a short messaging service (SMS), a multimedia messaging service (MMS), instant messaging, email, calendar, schedule management, alarm, health management, environment management, device search, and/or notification (for example, message reception, call reception, alarm, and/or update notification).

In an embodiment, the interworking function may include a function that, when information related to an application executed or installed in the electronic device 210 is transmitted to the external electronic device 220, the external electronic device 220 provides to the user by using the predetermined information. In an embodiment, the interworking function may include a function by which, when information related to an application executed or installed in the electronic device 210 or a control command is transmitted from the external electronic device 220 to the electronic device 210, the electronic device 210 operates according to the predetermined information or control command. In an embodiment, the interworking function may include a function by which, when information related to an application executed or installed in the external electronic device 220 is transmitted to the electronic device 210, the electronic device 210 operates according to the data. In an embodiment, the interworking function may include a function by which, when information related to an application executed or installed in the external electronic device 220 or a control command is transmitted from the electronic device 210 to the external electronic device 220, the external electronic device 220 operates according to the predetermined information or control command.

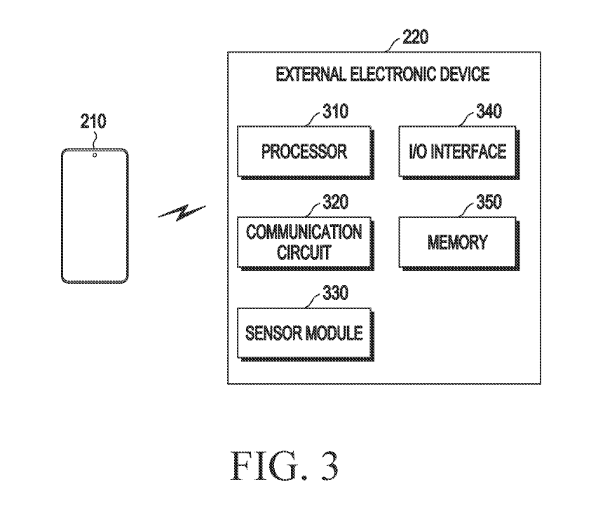

FIG. 3 is a block diagram illustrating a configuration of the external electronic device 220 according to an embodiment of the disclosure.

Referring to FIG. 3, the external electronic device 220 may include a processor 310, a communication circuit 320, a sensor module 330, and input/output (I/O) interface 340, and/or memory 350.

The processor 310 may receive information or a command from the above-described other components (for example, the communication circuit 320, the sensor module 330, the input/output interface 340, or the memory 350), interpret the information or command, and perform calculations or data processing according to the interpreted result.

The sensor module 330 may include one or more sensors. In an embodiment, the sensor module 330 may include sensors capable of detecting contact for an object (for example, the user) or whether it is worn, for example, an illumination sensor or a pressure sensor. In an embodiment, the sensor module 330 may include sensors capable of collecting biometric information and/or health information of the user, for example, an optical heart rate sensor, an electrical heart rate sensor, a body temperature measurement sensor, a pulse measurement sensor, or a sound wave sensor. In an embodiment, the sensor module 330 may include motion recognition sensors, for example, at least one of a geomagnetic sensor, an acceleration sensor, an azimuth sensor, or a gyro sensor.

The memory 350 may store commands or data received from the processor 310 or other components (for example, the communication circuit 320, the sensor module 330, or the input/output interface 340) or generated by the processor 310 or other components. The memory 350 may store at least one function module, for example, an application. Each function module may be configured by software, firmware, hardware, or a combination of at least two thereof. In an embodiment, the function module included (for example, stored in the memory 350 or executed by the processor 310) in the external electronic device 220 may include at least one application related to at least one of a call, an SMS/MMS, instant messaging, email, calendar, schedule management, alarm, device search, health management (for example, measurement of health information and/or biometric information), or environment management (for example, provision of environment information such as air pressure, humidity, or temperature). In an embodiment, the function module may include an application related to information exchange between the external electronic device 220 and the electronic device 210, for example, a notification relay application for transmitting and receiving specific information or a device management application for managing the external electronic device 220.

The notification relay application may include a function of transferring notification information generated by another application (for example, an SMS/MMS application, an email application, a device search application, a health management application, an environment management application, or the like) of the external electronic device 220 to the electronic device 210. Additionally or alternatively, the notification relay application may receive, for example, notification information from the electronic device 210 and provide the same to the user. For example, the device management application may manage (for example, install, delete, or update) functions of at least some of the electronic device 210 which communicates with the external electronic device 220 (for example, turning on/off all or some of the modules of the electronic device 210 or controlling brightness (or resolution) of the display), an application operating in the electronic device 210, or a service (for example, a call service or a message service) provided by the electronic device 210.

In an embodiment, the external electronic device 220 may include at least one predetermined application according to attributes (for example, the type of the external electronic device 220 or a device configuration) of the external electronic device 220. For example, when the external electronic device 220 includes a speaker, the external electronic device 220 may include an application related to music reproduction. For example, when the external electronic device 220 is a mobile medical device, the external electronic device 220 may include an application related to health management.

In an embodiment, the external electronic device 220 may include at least one application that can be synchronized with the electronic device 210 (for example, data synchronization). For at least one application supporting data synchronization, the external electronic device 220 may share at least some of the data generated or stored in the electronic device 210 with the electronic device 210 for the same application included (for example, stored, installed, or executed) in the electronic device 210.

The memory 350 may store reference information for determining state information of the user for the external electronic device 220 according to embodiments. According to an embodiment, the state information may include at least one of the states where the user is wearing and is not wearing the external electronic device 220, a user's sleep state (or doze state) or non-sleep state, or a battery state of the external electronic device 220 (for example, a battery level). The reference information may include information for determining the state where the user is wearing or is not wearing the external electronic device 220 and information that is the reference for determining the user's sleep state or non-sleep state (for example, threshold values or a threshold range for the sensor module 330).

The reference information for the wearing state or the non-wearing state may include sensor values, for example, a sensor value indicating the contact state of a sensor capable of detecting context between the external electronic device 220 and an external object (for example, the user) and a valid sensor value of each sensor capable of measuring biometric information and/or health information. The reference information for the sleep state or the non-sleep state may include sensor values, for example, a sensor value corresponding to each sensor capable of measuring user's biometric information which can be determined as the sleep state or a sensor value of a motion recognition sensor which can be determined as a stop state.

The input/output interface 340 may transfer commands or data input from the user to at least one of the processor 310, the memory 350, or the communication circuit 320 through an input/output module (for example, a sensor, a keyboard, or a touch screen). For example, the input/output interface 340 may provide data on a user's touch (for example, a user input) input through the touch screen to the processor 310. The input/output interface 340 may output commands or data received from at least one of the processor 310, the memory 350, or the communication circuit 320 through an input/output module (for example, a speaker or a display). For example, the input/output interface 340 may output audio data processed through the processor 310 to the user through the speaker. For example, the input/output interface 340 may display alarm or text processed through the processor 310.

The communication circuit 320 may perform communication (for example, data connection) between the electronic device 210 and the external electronic device 220. In an embodiment, the communication circuit 320 may be connected to a network (for example, the first network 198 or the second network 199) through wireless communication or wired communication to communicate with the electronic device 210. In an embodiment, the communication circuit 320 may include a Bluetooth module (for example, a Bluetooth module 418) supporting Bluetooth communication.

The processor 310 may process at least some of information acquired from other components (for example, the communication circuit 320, the sensor module 330, the input/output (I/O) interface 340, or the memory 350) and provide the same to the user through various methods. In an embodiment, the processor 310 may periodically identify whether the user uses the external electronic device 220. For example, the processor 310 may identify the wearing/non-wearing state of the external electronic device 220, the battery state, or the sleep/non-sleep state of the user periodically or based on a predetermined event.

When it is determined that the external electronic device 220 is not worn, the user is in the sleep state (for example, motion or biometric information is not detected for a predetermined time), the electronic device is in a charging state, or the battery state is a low-power level (for example, lower than a predetermined low-power threshold value), the processor 310 may generate or maintain the data connection (for example, a first data connection) in which some operations (for example, data synchronization for each application) of the electronic device 210 and the external electronic device 220 are limited. When it is determined that the external electronic device 220 is in the wearing state, the user is in the non-sleep state (for example, motion or biometric information is detected), or the battery state is in a non-low-power state (for example, higher than a predetermined power threshold value), the processor 310 may make a request for switching to the data connection (for example, a second data connection) in which the function (for example, data synchronization for each application) is not limited to the electronic device 210.

The processor 310 may maintain the first data connection, based on a predetermined state of the external electronic device 220 (for example, at least one of the non-wearing state, the charging state, the sleep state, or the low-power state (for example, lower than the predetermined low-power threshold value).

When the electronic device 210 is connected to the external electronic device 220 by using Bluetooth technology, functions and characteristics required for communication with the external electronic device 220 may be defined by at least one of profiles designated for the Bluetooth connection. The profiles may define not only peer-to-peer interactions (for example, between the electronic device 210 and the external electronic device 220) but also vertical interactions between layers (for example, a logical link control and adaptation protocol (L2CAP) layer, a link manager layer, a baseband layer, and a physical layer). In an embodiment, profiles available for the Bluetooth connection may include at least one of an advanced audio distribution profile (A2DP) for a music application, a hands-free profile (HFP) for a phone application, or a serial port profile (SPP) for data sharing.

In an embodiment, the electronic device 210 and the external electronic device 220 may establish one Bluetooth connection (for example, the data interface or the data connection) using the SPP and provide various functions through the data connection. In an embodiment, function modules (for example, applications) included (for example, stored, installed, or executed) in the electronic device 210 and the external electronic device 220 may share (for example, synchronize) data therebetween through the data connection. When the data connection is established, the electronic device 210 and the external electronic device 220 may synchronize function modules through the data connection.

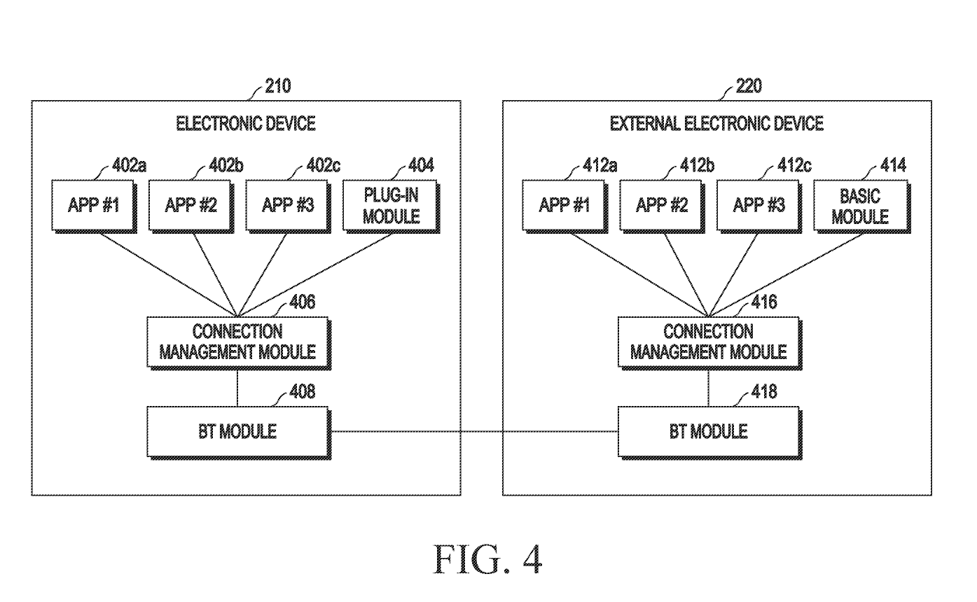

FIG. 4 is a diagram illustrating data synchronization through the Bluetooth connection according to an embodiment of the disclosure.

Referring to FIG. 4 , the electronic device 210 (for example, the processor 120) may include (for example, store, install, or execute) one or more applications (for example, APP#1 402a, APP#2 402b, APP#3 402c, and/or a plug-in module 404) related to Bluetooth communication with the external electronic device 220 and a connection management module 406. The electronic device 210 (for example, the processor 120 or the wireless communication module 192) may include a Bluetooth (BT) module 408. At least one of APP#1 402a, APP#2 402b, APP#3 402c, or the plug-in module 404 may use the data connection generated by the Bluetooth module 408 through the connection management module 406.

The external electronic device 220 (for example, the processor 310) may include (for example, store, install, or execute) one or more applications (for example, APP#1 412a, APP#2 412b, APP#3 412c, and/or a basic module 414 (for example, a watch basic application)) related to Bluetooth communication with the electronic device 210 and the connection management module 416. The external electronic device 220 (for example, the processor 310 or the communication circuit 320) may include the Bluetooth (BT) module 418. At least one of APP#1 412a, APP#2 412b, APP#3 412c, or the basic module 414 may use the data connection generated by the Bluetooth module 418 through the connection management module 416.

APP# 1 412a may be synchronized (for example, may share relevant data) with APP#1 402a. For example, APP#1 412a and APP#1 402a are instant messaging applications, and the relevant data may include a user state and/or chatting data. APP#2 412b may be synchronized (for example, may share relevant data) with APP#2 402b. For example, APP#2 412b and APP#2 402b are device search applications, and relevant data may include location information of the electronic device 210 and/or the external electronic device 220. APP#3 412c may be synchronized (for example, may share relevant data) with APP#3 402c. For example, APP#3 412c and APP#3 402c are health- related applications, and relevant data may include user's biometric information and/or health information. The basic module 414 may be synchronized (for example, may share relevant information) with the plug-in module 404, and relevant data may include connection information between the electronic device 210 and the external electronic device 220.

The electronic device 210 (for example, the Bluetooth module 408) may establish the Bluetooth connection (for example, the data connection using the Bluetooth profile) with the external electronic device 220 (for example, the Bluetooth module 418). When the electronic device 210 can be connected to the external electronic device 220 (For example, when the external electronic device 220 is located within the distance in which communication with the electronic device 210 is possible), the electronic device 210 may establish the data connection with the external electronic device 220, based on Bluetooth, and operate applications (for example, APP#1 402c, APP#2 402b, APP#3 402c, and/or the plug-in module 404) related to Bluetooth communication as soon as the data connection is established.

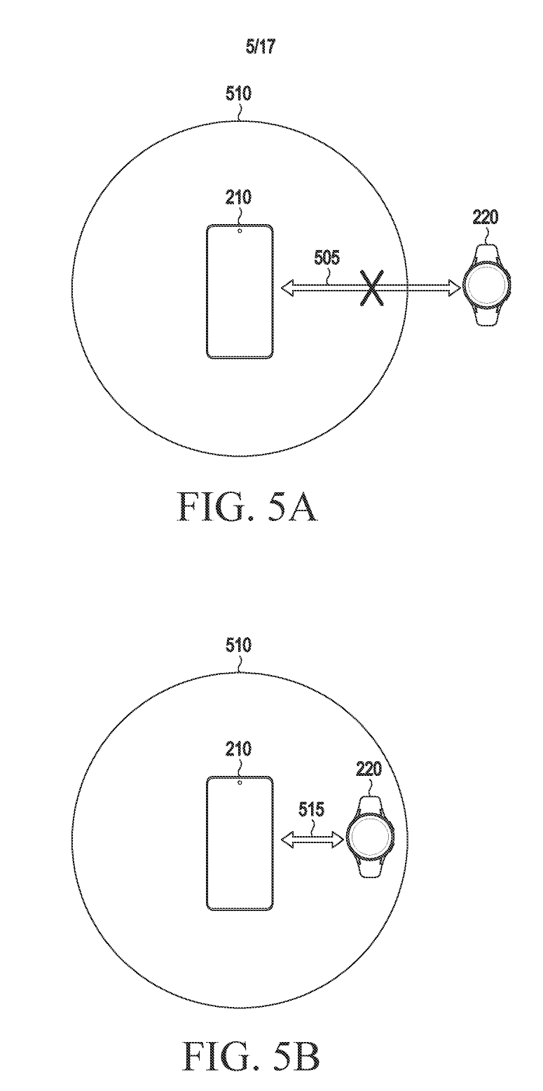

FIGS. 5A and 5B are diagrams illustrating the disconnection and the connection of Bluetooth communication according to various embodiments of the disclosure.

Referring to FIG. 5A, after the electronic device 210 and the external electronic device 220 establish a data connection 505 based on Bluetooth communication, the data connection 505 between the electronic device 210 and the external electronic device 220 may be disconnected when the external electronic device 220 leaves a service area 510 in which Bluetooth communication with the electronic device 210 is possible. For example, when the received signal strength (received signal strength indicator (RSSI)) of a signal (for example, a signal including advertising data) received from the external electronic device 220 does not exceed a predetermined threshold value (for example, RSSI_TH), the electronic device 210 may disconnect the data connection 505 with the external electronic device 220. Similarly, the external electronic device 220 may disconnect the data connection 505 with the electronic device 210, based on the predetermined threshold value.

Referring to FIG. 5B, the electronic device 210 may establish a data connection 515 with the external electronic device 220, based on entry of the external electronic device 220 into the service area 510 being detected. When the data connection 515 is established, the electronic device 210 may synchronize data for each of the applications of the electronic device 210 (for example, APP#1 402a, APP#2 402b, APP#3 402c, and/or the plug-in module 404). Similarly, the external electronic device 220 may establish data synchronization with the electronic device 210 for each of the applications (for example, APP#1 412a, APP#2 412b, APP#3 412c, and/or the basic module 414).

Simultaneously with establishment of the data connection (for example, the data connection 505 or the data connection 515), the electronic device 210 and the external electronic device 220 may start data synchronization of the applications (for example, APP#1 402a, APP#2 402b, APP#3 402c, the plug-in module 404, APP#1 412a, APP#2 412b, APP#3 412c, and/or the basic module 414.

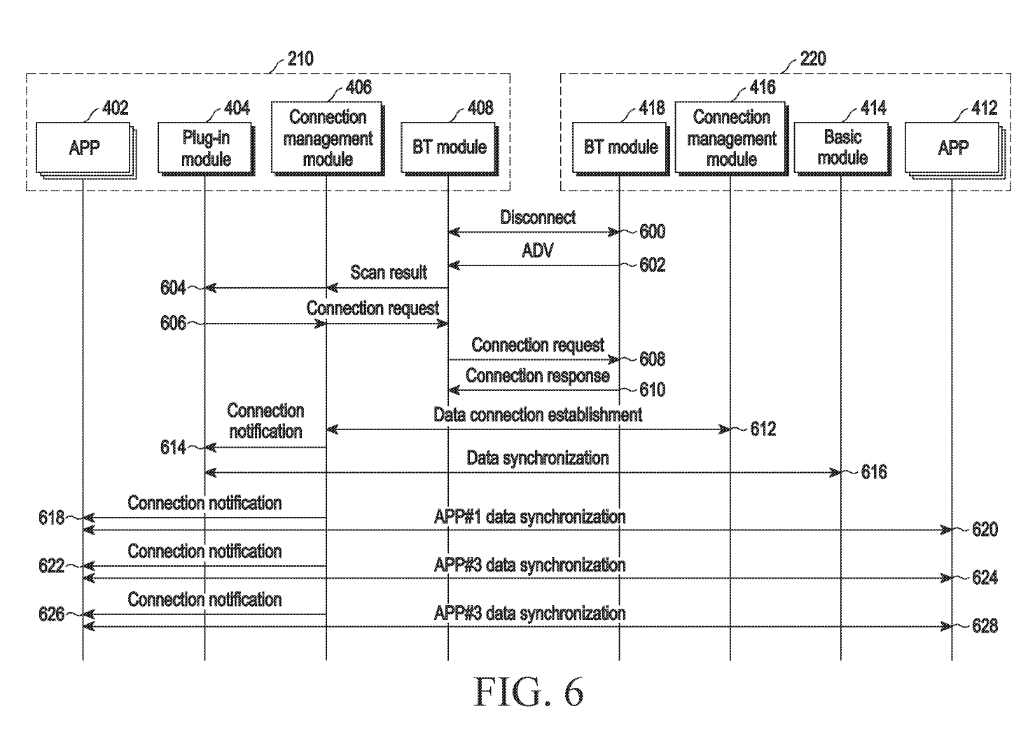

FIG. 6 illustrates a sequence diagram for describing the data connection and data synchronization according to an embodiment of the disclosure. According to embodiments, at least one of the operations described below may be omitted or modified, or the order thereof may be changed.

Referring to FIG. 6, in operation 600, the electronic device 210 and the external electronic device 220 may disconnect the Bluetooth connection. In an embodiment, the electronic device 210 may store information on the external electronic device 220 to be used for a reconnection with the external electronic device 220. In an embodiment, the external electronic device 220 may store information on the electronic device 210 to be used for a reconnection with the electronic device 210.

In operation 602, the external electronic device 220 (for example, the Bluetooth module 418) may transmit (for example, broadcast) advertising data (for example, an ADV protocol data unit (PDU)) periodically (for example, according to an advertising interval). The electronic device 210 (for example, the Bluetooth module 408) may discover the external electronic device 220 by receiving the advertising data through a Bluetooth scan operation. In operation 604, the electronic device 210 (for example, the Bluetooth module 408) may transfer a scan result related to reception of the advertising data to the plug-in module 404 through, for example, the connection management module 406. In operation 606, the electronic device 210 (for example, the plug-in module 404 may transfer a connection request that makes a request for the connection with the external electronic device 220 to the Bluetooth module 408 through, for example, the connection management module 406.

In operation 608, the electronic device 210 (for example, the Bluetooth module 408) may transmit a connection request message (for example, a connection request PDU) to the external electronic device 220 through a radio channel (for example, a Bluetooth channel). In operation 610, the external electronic device 220 (for example, the Bluetooth module 418) may transmit a connection response message (for example, a connection response PDU) to the electronic device 210 through a radio channel. In operation 612, the electronic device 210 and the external electronic device 220 may establish a Bluetooth connection (for example, a data connection of a data layer). In an embodiment, a physical layer connection based on Bluetooth technology may be established between the Bluetooth module 408 of the electronic device 210 and the Bluetooth module 418 of the external electronic device 220, and a data layer connection based on the physical layer connection may be established between the connection management module 406 of the electronic device 210 and the connection management module 416 of the external electronic device 220. In the disclosure, the data connection may include the physical layer connection and/or the data layer connection.

In operation 614, the electronic device 210 (for example, the connection management module 406) may transmit a connection notification informing of establishment of the data connection to the plug-in module 404. In operation 616, the electronic device 210 (for example, the plug-in module 404) may perform data synchronization for sharing data related to the basic module 414 of the external electronic device 220 through the data connection. In an embodiment, the electronic device 210 (for example, the connection management module 406) may transmit relevant data generated by the operation of the connection management module 406 to the external electronic device 220 through the data connection. In an embodiment, the external electronic device 220 (for example, the connection management module 416) may transmit relevant data generated by the operation of the connection management module 406 to the electronic device 210.

In operation 618, the electronic device 210 (for example, the connection management module 406) may transmit a connection notification informing of establishment of the data connection to at least one application module (APP) 402 (for example, APP#1 402a). In operation 620, the electronic device 210 (for example, APP# 1402a) may perform data synchronization for sharing relevant data with the application module (APP) 412 (for example, APP# 1412a) of the external electronic device 220 through the data connection. In an embodiment, operation 620 may include at least one of the operation in which the electronic device 210 transmits data related to APP# 1402a to the external electronic device 220 through the data connection or the operation in which the external electronic device 220 transmits data related to APP#1 412a to the electronic device 210 through the data connection.

In operation 622, the electronic device 210 (for example, the connection management module 406) may transmit a connection notification informing of establishment of the data connection to at least one application module (APP) 402 (for example, APP#2 402b). In operation 624, the electronic device 210 (for example, APP#2 402b) may perform data synchronization for sharing data related to the application module (APP) 412 (for example, APP#2 412b) of the external electronic device 220 through the data connection. In an embodiment, operation 624 may include at least one of the operation in which the electronic device 210 transmits data related to APP#2 402b to the external electronic device 220 through the data connection or the operation in which the external electronic device 220 transmits data related to APP#2 412b to the electronic device 210 through the data connection.

In operation 626, the electronic device 210 (for example, the connection management module 406) may transmit a connection notification informing of establishment of the data connection to at least one application module (APP) 402 (for example, APP#3 402c). In operation 628, the electronic device 210 (for example, APP#3 402c) may perform data synchronization for sharing data related to the application module (APP) 412 (for example, APP#3 412c) of the external electronic device 220 through the data connection. In an embodiment, operation 628 may include at least one of the operation in which the electronic device 210 transmits data related to APP#3 402c to the external electronic device 220 through the data connection or the operation in which the external electronic device 220 transmits data related to APP#3 412c to the electronic device 210 through the data connection.

As described above, when the data connection is established, for applications (for example, APP#1 402a, APP#2 402b, APP#3 402c, and/or the plug-in module 404) using Bluetooth communication, the electronic device 210 may perform data synchronization with applications (for example, APP#1 412a, APP#2 412b, APP#3 412c, and/or the plug-in module (basic module 414)) of the external electronic device 220.

For example, when the external electronic device 220 is located at a boundary of the service area 510 in which the connection with the electronic device 210 is possible, the unnecessary data synchronization operation and power consumption may be frequently generated as the connection and the disconnection of the data connection (for example, the data connection 505 or the data connection 515) are repeated. Such a situation may be generated at home, when the external electronic device 220 or the electronic device 210 is charged, or when the external electronic device 220 is not worn on the user. For example, when the external electronic device 220 repeats the connection with and the disconnection from the electronic device 210 in the non-wearing state, unnecessary functions such as vibration or turning on the light may be performed in the state where the user does not exist, and thus power consumption of the external electronic device 220 may be caused and bad experience may be transferred to the user.

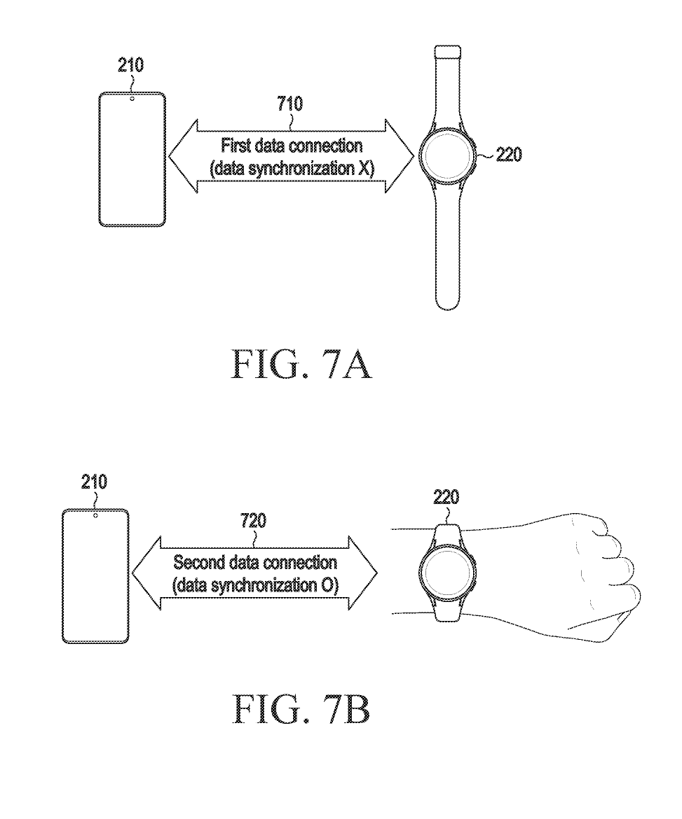

FIG. 7A is a diagram illustrating a Bluetooth connection that does not include data synchronization according to an embodiment of the disclosure.

Referring to FIG. 7A, the electronic device 210 may establish a predetermined Bluetooth connection (for example, a first data connection 710) with the external electronic device 220 not to perform data synchronization, based on a predetermined state of the external electronic device 220. In an embodiment, the predetermined state may include at least one of the non-wearing state of the external electronic device 220, the charging state, the sleep state, or the low-power state. After establishing the first data connection 710 with the external electronic device 220, the electronic device 210 may maintain the first data connection 710 without performing data synchronization for applications (for example, APP#1 402a, APP#2 402b, APP#3 402c, and/or the plug-in module 404) using Bluetooth communication included (for example, stored, installed, or executed) in the electronic device 210.

In an embodiment, the second data connection 720 may apply a second profile defining at least one function including data synchronization for each application. The second data connection 720 may use behaviors and data formats defined by the second profile.

FIG. 7B is a diagram illustrating a Bluetooth connection including data synchronization according to an embodiment of the disclosure.

Referring to FIG. 7B, the electronic device 210 may switch the first data connection 710 with the external electronic device 220 to a Bluetooth connection (for example, a second data connection 720) including data synchronization, based on the external electronic device 220 being in a predetermined state. In an embodiment, the predetermined state may include at least one of the wearing state of the external electronic device 220, the non-charging state, the non-sleep state, or the non-lower- power state. In an embodiment, the predetermined state may include a state that is not the predetermined state related to the first data connection 710. After establishing the second data connection 720 with the external electronic device 220, the electronic device 210 may perform data synchronization for applications (for example, APP#1 402a, APP#3 402b, APP#3 402c, and/or the plug-in module 404) using Bluetooth communication included (for example, stored, installed, or executed) in the electronic device 210 through the second data connection 720.

In an embodiment, the first data connection 710 may apply a first profile defining at least one function that does not include data synchronization for each application. The first data connection 710 may use behaviors and data formats defined by the first profile.

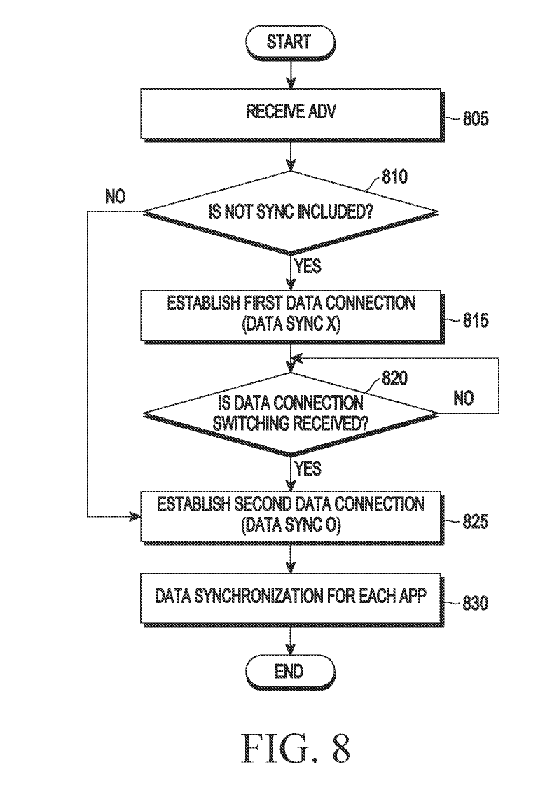

FIG. 8 is a flowchart illustrating a procedure of the electronic device controlling a Bluetooth connection, based on advertising data, according to an embodiment of the disclosure. At least one of the operations described below according to an embodiment may be performed by the processor 120 of the electronic device 210. According to embodiments, at least one of the operations described below may be omitted or modified, or the order thereof may be changed.

Referring to FIG. 8, in operation 805, the electronic device 210 (for example, the processor 120)may receive advertising data (ADV) (for example, advertising data 1002) broadcasted by the external electronic device 220. In an embodiment, the electronic device 210 (for example, the processor 120) may identify that the electronic device has been previously connected to the external electronic device 220, based on identification information (for example, a media access control (MAC) address) of the external electronic device 220 included in the advertising data and a reconnection with the external electronic device 220 is needed.

In operation 810, the electronic device 210 (for example, the processor 120) may determine whether the advertising data includes information (for example, a value 1018 indicating a NOT SYNC mode) indicating a predetermined Bluetooth connection (for example, the first data connection 710) not to perform data synchronization. When the advertising data includes the information (NOT SYNC), the electronic device 210 (for example, the processor 120) may proceed to operation 815. When the advertising data does not include the information (NOT SYNC), the electronic device 210 (for example, the processor 120) may proceed to operation 825.

In operation 815, the electronic device 210 (for example, the processor 120) may establish the predetermined first data connection (for example, the first data connection 710) with the external electronic device 220 not to perform data synchronization. In an embodiment, the electronic device 210 (for example, the processor 120) may establish the first data connection by transmitting a connection request (for example, a connection request in operation 1108) including information indicating the first profile to the external electronic device 220. In an embodiment, during the first data connection, the electronic device 210 (for example, the processor 120) may not perform data synchronization for one or more applications (for example, APP#1 402a, APP#2 402b, APP#3 402c, and/or the plug-in module 404) related to the external electronic device 220. In an embodiment, during the first data connection, one or more applications for which data synchronization is limited may be predetermined by a user, a manufacturer, or an application developer. In an embodiment, the electronic device 210 (for example, the processor 120) may perform data synchronization for, for example, a device search (find my device) application and/or an emergency notification application among the applications related to the external electronic device 220 even during the first data connection.

In operation 820, the electronic device 210 (for example, the processor 120) may determine whether switching of the data connection with the external electronic device 220 is needed while maintaining the first data connection. In an embodiment, as receiving a data connection switching message (for example, a data connection switching request message in operation 1122) from the external electronic device 220, the electronic device 210 (for example, the processor 120) may determine that switching of the data connection with the external electronic device 220 is needed. In an embodiment, based on reception of the data connection switching message, the electronic device 210 (for example, the processor 120) may determine that the external electronic device 220 is in predetermined states (for example, at least one of the wearing state, the non-charging state, the non-sleep state, or the non-low-power state) in which it is determined that switching from the first data connection in which data synchronization is not performed to the second data connection in which data synchronization is performed is needed. When it is determined that switching of the data connection with the external electronic device 220 is needed, the electronic device 210 (for example, the processor 120) may proceed to operation 825. When it is not determined that switching of the data connection with the external electronic device 220 is needed, the electronic device 210 (for example, the processor 120) may maintain the first data connection.

In operation 825, the electronic device 210 (for example, the processor 120) may establish a predetermined second data connection (for example, the second data connection 720) with the external electronic device 220 to perform data synchronization. In an embodiment, the electronic device 210 (for example, the processor 120) may perform data connection switching by disconnecting the first data connection and establishing the second data connection for the external electronic device 220.

In operation 830, for applications (for example, APP#1 402a, APP#2 402b, APP#3 402c, and/or the plug-in module 404) related to the external electronic device 220 included (for example, stored, installed, or executed) in the electronic device 210, the electronic device 210 (for example, the processor 120) may perform data synchronization (for example, operations 618 to 628) for each application through the second data connection.

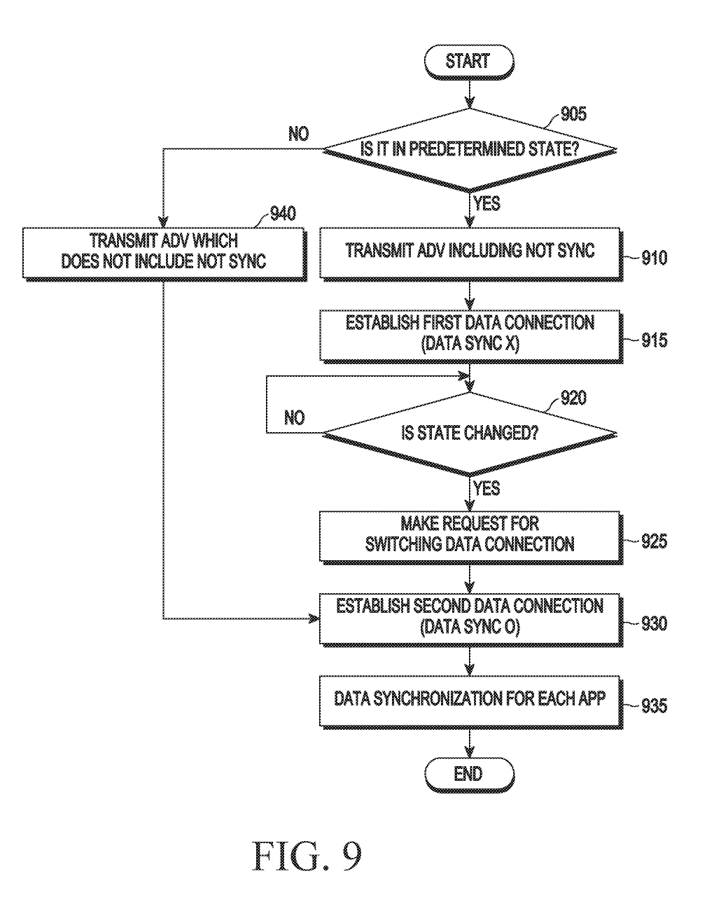

FIG. 9 is a flowchart illustrating a procedure of the external electronic device transmitting advertising data for controlling a Bluetooth connection according to an embodiment of the disclosure. At least one of the operations described below according to an embodiment may be performed by the processor 310 of the external electronic device 220. According to embodiments, at least one of the operations described below may be omitted or modified, or the order thereof may be changed.

Referring to FIG. 9 , in operation 905, the external electronic device 220 (for example, the processor 310) may periodically determine whether, for example, the external electronic device 220 satisfies a predetermined state while the connection with the electronic device 210 is disconnected. The external electronic device 220 (for example, the processor 310) may perform operation 905, based on the previous Bluetooth connection with the electronic device 210 being disconnected and information required for the reconnection with the electronic device 210 being stored. In an embodiment, the predetermined state may include at least one of the non-wearing state of the external electronic device 220, the charging state, the sleep state, and the low-power state. In the case of the predetermined state, the external electronic device 220 (for example, the processor 310) may proceed to operation 910. In the case other than the predetermined state, the external electronic device 220 (for example, the processor 310) may proceed to operation 940.

In operation 910, the external electronic device 220 (for example, the processor 310) may broadcast first advertising data (for example, ADV) (for example, advertising data 1002) including information (for example, a value 1018 indicating a NOT SYNC mode) indicating a predetermined Bluetooth connection (for example, the first data connection 710) not to perform data synchronization. After broadcasting the first advertising data, the external electronic device 220 (for example, the processor 310) may proceed to operation 915.

In operation 940, the external electronic device 220 (for example, the processor 310) may broadcast second advertising data (for example, ADV) (for example, advertising data 1002) that does not include the information (for example, the value 1018 indicating the NOT SYNC mode). After broadcasting the second advertising data, the external electronic device 220 (for example, the processor 310) may proceed to operation 930.

In operation 915, the external electronic device 220 (for example, the processor 310) may establish a predetermined first data connection (for example, the first data connection 710) with the electronic device 210 not to perform data synchronization, based on a connection request (for example, a connection request in operation 1108) of the electronic device 210 receiving the first advertising data. During the first data connection, the external electronic device 220 (for example, the processor 310) may not perform data synchronization with the electronic device 210 for one or more applications ((for example, APP#1 412a, APP#2 412b, APP#3 412c, and/or the basic module 414) except for at least one predetermined application. The at least one predetermined application may include, for example, a find my device and/or emergency notification application.

In operation 920, the external electronic device 220 (for example, the processor 310) may determine whether a predetermined state change requiring data connection switching is detected. In an embodiment, when escaping the predetermined state in operation 905, the external electronic device 220 (for example, the processor 310) may determine that the state change is detected. In an embodiment, the state change may include at least one of entry into at least one of the wearing state of the external electronic device 220, the non-charging state, the non-sleep state, and the non- low-power state, movement of the external electronic device 220, or a user input. When the state change is detected, the external electronic device 220 (for example, the processor 310) may proceed to operation 925. When the state change is not detected, the external electronic device 220 (for example, the processor 310) may maintain the first data connection.

In operation 925, the external electronic device 220 (for example, the processor 310) may transmit a data connection switching message (for example, a data connection switching request message in operation 1122) to the electronic device 210. In an embodiment, the data connection switching message may include information (for example, a value 1016 indicating a NORMAL mode) for making a request for the predetermined second data connection to perform data synchronization. In an embodiment, the data connection switching message may include information indicating the state change of the external electronic device 220.

In operation 930, the external electronic device 220 (for example, the processor 310) may establish the predetermined second data connection (for example, the second data connection 720) with the electronic device 210 to perform data synchronization, based on a connection request (for example, a connection request in operation 1126) of the electronic device 210 receiving the data connection switching message. In an embodiment, the external electronic device 220 (for example, the processor 310) may switch the data connection by disconnecting the first data connection and establishing the second data connection for the electronic device 210. In operation 935, the external electronic device 220 (for example, the processor 310) may perform data synchronization for each application with the electronic device 210 through the second data connection. In an embodiment, the external electronic device 220 (for example, the processor 310) may perform data synchronization for each application (for example, operations 618 to 628) for applications (for example, APP#1 412a, APP#2 412b, APP#3 412c, and/or the basic module 414) using Bluetooth communication included (for example, stored, installed, or executed) in the external electronic device 220.

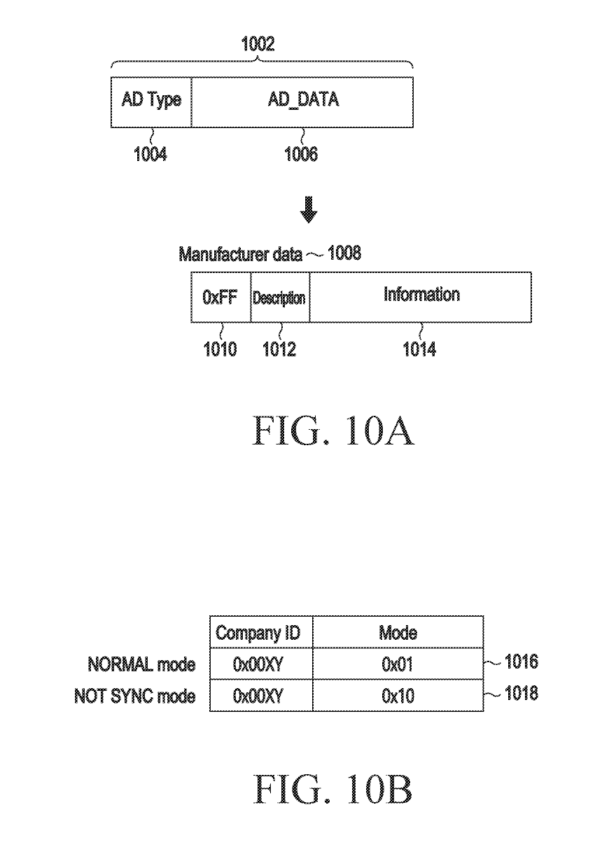

FIGS. 10A and 10B are diagrams illustrating formats of advertising data including information that controls a data connection according to various embodiments of the disclosure.

Referring to FIG. 10A, advertising data 1002 may include an advertising type field (for example, AD_Type) 1004 and an advertising data field (for example, AD_DATA) 1006. The advertising data field 1006 may include a manufacture data (manufacturer specific data) field 1008, and the manufacturer data field 1008 may include a type field 1010, a description field 1012, and an information field 1014.

Referring to FIG. 10B, the information field 1014 may include a company ID and a mode value. In an embodiment, the mode value may include one of the value 1016 (for example, Ox01) indicating the second data connection (for example, the NORMAL mode) including data synchronization) or the value 1018 (for example, 0x10) indicating the first data connection (for example, the NOT SYNC mode) that does not include data synchronization.

In an embodiment, the external electronic device 220 may include the value 1018 indicating the NOT SYNC mode into the advertising data 1002, based on at least one of the non-wearing state, the charging state, the sleep state, or the low-power state being detected while the external electronic device waits for the reconnection with the electronic device 210.

In an embodiment, the electronic device 210 may recognize whether the external electronic device 220 is in a predetermined state (for example, at least one of the non-wearing state, the charging state, the sleep state, or the low-power state), based on the broadcasted advertising data 1002. In an embodiment, the electronic device 210 may determine to establish a data connection (for example, the first data connection 710) with the external electronic device 220 in which some operations (for example, data synchronization) are limited based on inclusion of predetermined information (for example, the value 1018 indicating the NOT SYNC mode) in the advertising data 1002 received from the external electronic device 220 being identified.

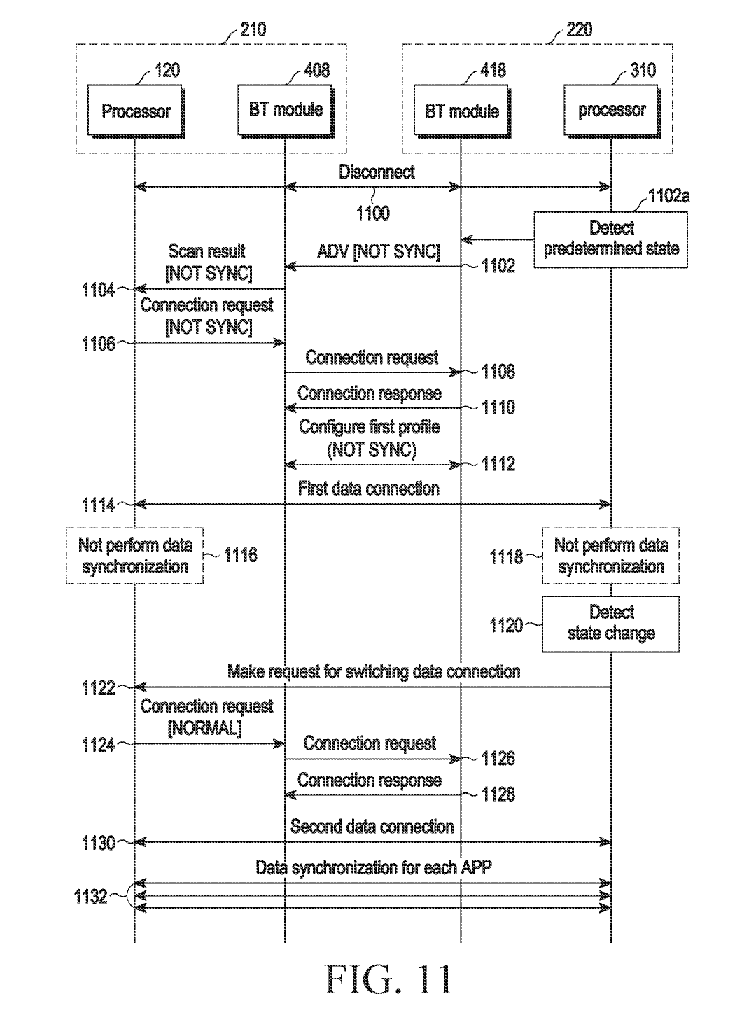

FIG. 11 illustrates a sequence diagram illustrating a procedure of controlling a Bluetooth connection, based on advertising data, according to an embodiment of the disclosure. According to embodiments, at least one of the operations described below may be omitted or modified, or the order thereof may be changed.

Referring to FIG. 11 , in operation 1100, the electronic device 210 and the external electronic device 220 may disconnect the Bluetooth connection. In an embodiment, as the external electronic device 220 leaves a range (for example, the service area 510)in which Bluetooth communication with the electronic device 210 is possible, the Bluetooth connection between the electronic device 210 and the external electronic device 220 may be disconnected. In an embodiment, the electronic device 210 may store information on the external electronic device 220 to be used for a reconnection with the external electronic device 220. In an embodiment, the external electronic device 220 may store information on the electronic device 210 to be used for a reconnection with the electronic device 210. In an embodiment, the electronic device 210 (for example, the Bluetooth module 408) may transmit a disconnection notification to the processor 120 and perform BLE scan for an automatic reconnection, based on a BLE scan request (not shown) being received from the processor 120.

In operation 1102a, the external electronic device 220 (for example, the processor 310) may periodically determine the current state with the external electronic device 220 at a time point at which the connection with the electronic device 210 is disconnected and determine that the external electronic device 220 is in the predetermined state. In an embodiment, the external electronic device 220 (for example, the Bluetooth module 418) may transmit a disconnection notification to the processor 310, and the external electronic device 220 (for example, the processor 310) may determine whether the current state of the external electronic device 220 is the predetermined state (for example, at least one of the non-wearing state, the charging state, the sleep state, or the low-power state) at a time point at which the disconnection notification is received and periodically during the disconnection. The external electronic device 220 (for example, the basic module 414) may make a request for performing advertising including the value (for example, the value 1018) indicating the NOT SYNC mode to the Bluetooth module 418, based on the predetermined state being detected.

In operation 1102, the external electronic device 220 (for example, the Bluetooth module 418) may broadcast advertising data (for example, the advertising data 1002) including the value (for example, the value 1018) indicating the NOT SYNC mode in the manufacturer data field (for example, the manufacturer data field 1008). In an embodiment, when the external electronic device 220 moves and enters the range (for example, the service area 510) in which Bluetooth communication with the electronic device 210 is possible, the electronic device 210 (for example, the Bluetooth module 408) may receive the advertising data through BLE scan (for example, background BLE scan) for the automatic reconnection and identify that the advertising data includes the value indicating the NOT SYNC mode.

In operation 1104, the electronic device 210 (for example, the Bluetooth module 408) may transfer the scan result including information (for example, "NOT SYNC") indicating that the advertising data includes the value indicating the NOT SYNC mode to the processor 120 (for example, the processor 120). In operation 1106, the electronic device 210 (for example, the processor 120) may transmit a connection request including information (for example, "NOT SYNC") making a request for the data connection (for example, the first data connection 710) that does not include data synchronization to the Bluetooth module 408.

In operation 1108, the electronic device 210 (for example, the Bluetooth module 408) may transmit a connection request for the predetermined first data connection not to perform data synchronization to the external electronic device 220. In operation 1110, the external electronic device 220 (for example, the Bluetooth module 418) may transmit a connection response for the first data connection to the electronic device 210. In operation 1112, the electronic device 210 (for example, the Bluetooth module 408) and the external electronic device 220 (for example, the Bluetooth module 418) may configure a first profile defining at least one function that does not include data synchronization. In operation 1114, the electronic device 210 (for example, the processor 120) and the external electronic device 220 (for example, the processor 310) may recognize that the first data connection based on the first profile has been established. For example, the electronic device 210 (for example, the processor 120) may receive a connection notification from the Bluetooth module 408. For example, the external electronic device 220 (for example, the processor 310) may receive the connection notification from the Bluetooth module 418.

In operation 1116 and operation 1118, the electronic device 210 (for example, the processor 120) and the external electronic device 220 (for example, the processor 310) may identify that data synchronization for one or more applications related to the external electronic device 220 is not performed based on the predetermined first data connection being established not to perform data synchronization. Although not illustrated, in an embodiment, the electronic device 210 (for example, the processor 120) may perform data synchronization through the first data connection for at least one predetermined application (for example, a device search application and/or an emergency notification application) except for the applications related to the external electronic device 220. In an embodiment, the electronic device 210 (for example, the processor 120) and the external electronic device 220 (for example, the processor 310) may limit (for example, deactivate) the remaining applications except for the device search application and/or the emergency notification application during the first data connection.

In operation 1120, the external electronic device 220 (for example, the processor 310) may detect a state change requiring data connection switching. In an embodiment, when the external electronic device 220 enters at least one of the wearing state, the non-charging state, the non-sleep state, or the non-low-power state, when the external electronic device 220 moves, or when a user action (for example, a wearing or touch input) through the external electronic device 220 is detected, the external electronic device 220 (for example, the processor 310) may determine that the state change is detected.

In operation 1122, the external electronic device 220 (for example, the processor 310) may transmit a data connection switching request message to the electronic device 210. In an embodiment, the data connection switching request message may be transmitted to the electronic device 210 through the first data connection. In an embodiment, the data connection switching request message may include information (for example, a value indicating the NORMAL mode or a value indicating a second profile) making a request for the second data connection. In an embodiment, the data connection switching request message may include information indicating a state change of the external electronic device 220 or information indicating a changed state.

The electronic device 210 (for example, the processor 120) may determine to switch the first data connection to a data connection (for example, the second data connection 720) including data synchronization, based on the data connection switching request message being received.

In operation 1124, the electronic device 210 (for example, the processor 120) may transmit a connection request including information (for example, "NORMAL") making a request for the second data connection to the Bluetooth module 408. In operation 1126, the electronic device 210 (for example, the Bluetooth module 408) may transmit a connection request for a predetermined second data connection to the external electronic device 220 to perform data synchronization. In operation 1128, the external electronic device 220 (for example, the Bluetooth module 418) may transmit a connection response for the second data connection to the electronic device 210. Although not illustrated, in an embodiment, the electronic device 210 (for example, the Bluetooth module 408) and the external electronic device 220 (for example, the Bluetooth module 418) may configure a second profile that defines functions including data synchronization for the second data connection. In operation 1130, the electronic device 210 (for example, the processor 120) and the external electronic device 220 (for example, the processor 310) may recognize that the second data connection based on the second profile has been established. For example, the electronic device 210 (for example, the processor 120) may receive a connection notification from the Bluetooth module 408. For example, the external electronic device 220 (for example, the processor 310) may receive the connection notification from the Bluetooth module 418.

In operation 1132, the electronic device 210 (for example, the processor 120) and the external electronic device 220 (for example, the processor 310) may perform data synchronization for one or more applications through the second data connection. For example, operation 1132 may include at least one of operation 618 to operation 628.

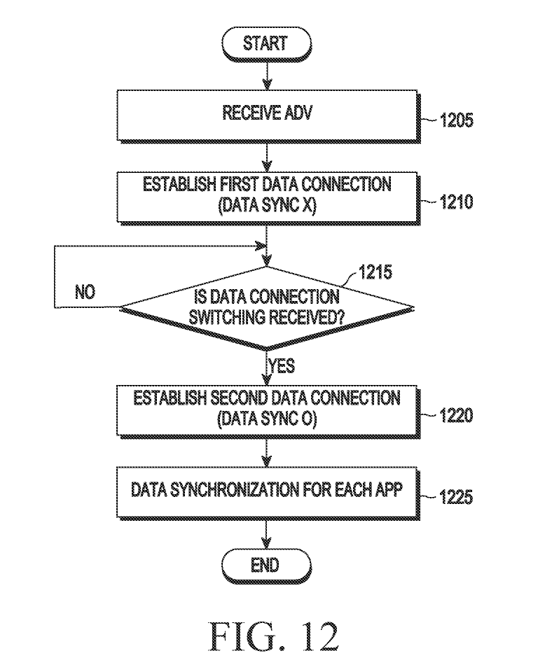

FIG. 12 is a flowchart illustrating a procedure of the electronic device that controls a Bluetooth connection according to an embodiment of the disclosure. At least one of the operations described below according to an embodiment may be performed by the processor 120 of the electronic device 210. According to embodiments, at least one of the operations described below may be omitted or modified, or the order thereof may be changed.

Referring to FIG. 12, in operation 1205, the electronic device 210 (for example, the processor 120) may receive advertising data (ADV) (for example, the advertising data 1002) broadcasted by the external electronic device 220. In an embodiment, the electronic device 210 (for example, the processor 120) may identify that the electronic device has been previously connected to the external electronic device 220, based on identification information (for example, a MAC address) of the external electronic device 220 included in the advertising data and an automatic reconnection with the external electronic device 220 is needed

In operation 1210, for the automatic reconnection with the external electronic device 220, the electronic device 210 (for example, the processor 120) may establish the predetermined first data connection (for example, the first data connection 710) with the external electronic device 220 not to perform data synchronization. In an embodiment, the electronic device 210 (for example, the processor 120) may establish the first data connection by transmitting a connection request (for example, a connection request in operation 1108) including information indicating the first profile to the external electronic device 220. In an embodiment, during the first data connection, the electronic device 210 (for example, the processor 120) may not perform data synchronization for one or more applications (for example, APP#1 402a, APP#2 402b, APP#3 402c, and/or the plug-in module 404) related to the external electronic device 220.

In operation 1215, the electronic device 210 (for example, the processor 120) may determine whether switching of the data connection with the external electronic device 220 is needed while maintaining the first data connection. In an embodiment, as receiving a data connection switching message (for example, a data connection switching request message in operation 1122) from the external electronic device 220, the electronic device 210 (for example, the processor 120) may determine that switching of the data connection with the external electronic device 220 is needed. In an embodiment, the electronic device 210 (for example, the processor 120) may determine that the external electronic device 220 is in a predetermined state (for example, the wearing state, the non-charging state, the non-sleep state, or the non-low- power state) requiring data connection switching to the normal mode, based on the data connection switching message being received. When it is determined that switching of the data connection with the external electronic device 220 is needed, the electronic device 210 (for example, the processor 120) may proceed to operation 1220. When it is not determined that switching of the data connection with the external electronic device 220 is needed, the electronic device 210 (for example, the processor 120) may maintain the first data connection.

In operation 1220, the electronic device 210 (for example, the processor 120) may establish a predetermined second data connection (for example, the second data connection 720) to perform data synchronization. In an embodiment, the electronic device 210 (for example, the processor 120) may perform data connection switching by disconnecting the first data connection and establishing the second data connection for the external electronic device 220.

In operation 1225, for applications (for example, APP#1 402a, APP#2 402b, APP#3 402c, and/or the plug-in module 404) related to the external electronic device 220 included (for example, stored, installed, or executed) in the electronic device 210, the electronic device 210 (for example, the processor 120) may perform data synchronization (for example, operations 618 to 628) for each application through the second data connection.

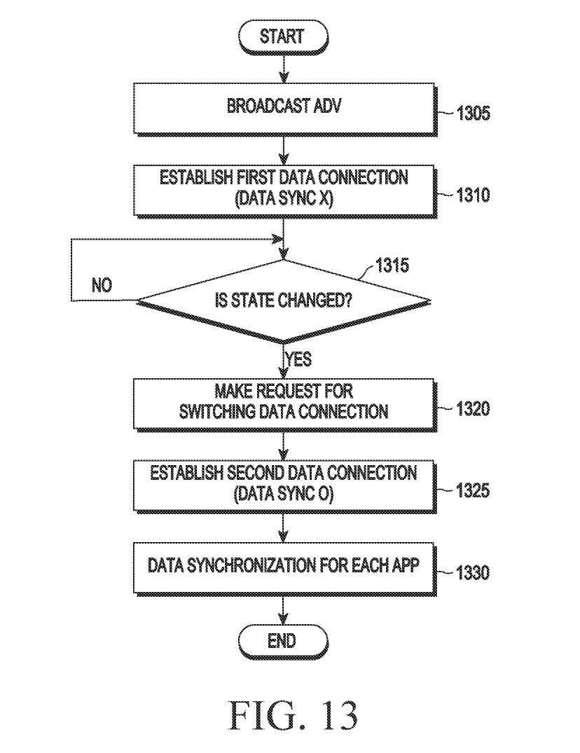

FIG. 13 is a flowchart illustrating a procedure of the external electronic device that controls a Bluetooth connection in the non-wearing state according to an embodiment of the disclosure. At least one of the operations described below according to an embodiment may be performed by the processor 310 of the external electronic device 220. According to embodiments, at least one of the operations described below may be omitted or modified, or the order thereof may be changed.

Referring to FIG. 13, in operation 1305, the external electronic device 220 (for example, the processor 310) may periodically transmit (for example, broadcast) advertising data (for example, the advertising data 1002) for the automatic reconnection with the electronic device 210 after the disconnection from the electronic device 210. In operation 1310, the external electronic device 220 (for example, the processor 310) may establish the predetermined first data connection not to perform data synchronization with the electronic device 210, based on a connection request from the electronic device 210 receiving the advertising data. During the first data connection, the external electronic device 220 (for example, the processor 310) may not perform data synchronization with the electronic device 210 for one or more applications (for example, APP#1 412a, APP#2 412b, APP#3 412c, and/or the basic module 414) except for at least one predetermined application. The at least one predetermined application may include, for example, a find my device and/or emergency notification application.

In operation 1315, the external electronic device 220 (for example, the processor 310) may determine whether a predetermined state change requiring data connection switching is detected. In an embodiment, the state change may include at least one of entry into at least one of the wearing state of the external electronic device 220, the non-charging state, the non-sleep state, and the non-low-power state, movement of the external electronic device 220, or a user input. When the state change is detected, the external electronic device 220 (for example, the processor 310) may proceed to operation 1320. When the state change is not detected, the external electronic device 220 (for example, the processor 310) may maintain the first data connection.

In operation 1320, the external electronic device 220 (for example, the processor 310) may transmit a data connection switching message (for example, a data connection switching request message in operation 1422) to the electronic device 210. In an embodiment, the data connection switching message may include information (for example, a value indicating a NORMAL mode or a value indicating a second profile) for making a request for the predetermined second data connection to perform data synchronization. In an embodiment, the data connection switching message may include information indicating the state change of the external electronic device 220 or information indicating a changed state.

In operation 1325, the external electronic device 220 (for example, the processor 310) may establish the predetermined second data connection (for example, the second data connection 720) with the electronic device 210 to perform data synchronization, based on a connection request (for example, a connection request in operation 1426) of the electronic device 210 receiving the data connection switching message. In an embodiment, the external electronic device 220 (for example, the processor 310) may switch the data connection by disconnecting the first data connection and establishing the second data connection for the electronic device 210. In operation 1330, the external electronic device 220 (for example, the processor 310) may perform data synchronization for each application with the electronic device 210 through the second data connection. In an embodiment, the external electronic device 220 (for example, the processor 310) may perform data synchronization for each application (for example, operations 618 to 628) for applications (for example, APP#1 412a, APP#2 412b, APP#3 412c, and/or the basic module 414) using Bluetooth communication included (for example, stored, installed, or executed) in the external electronic device 220.

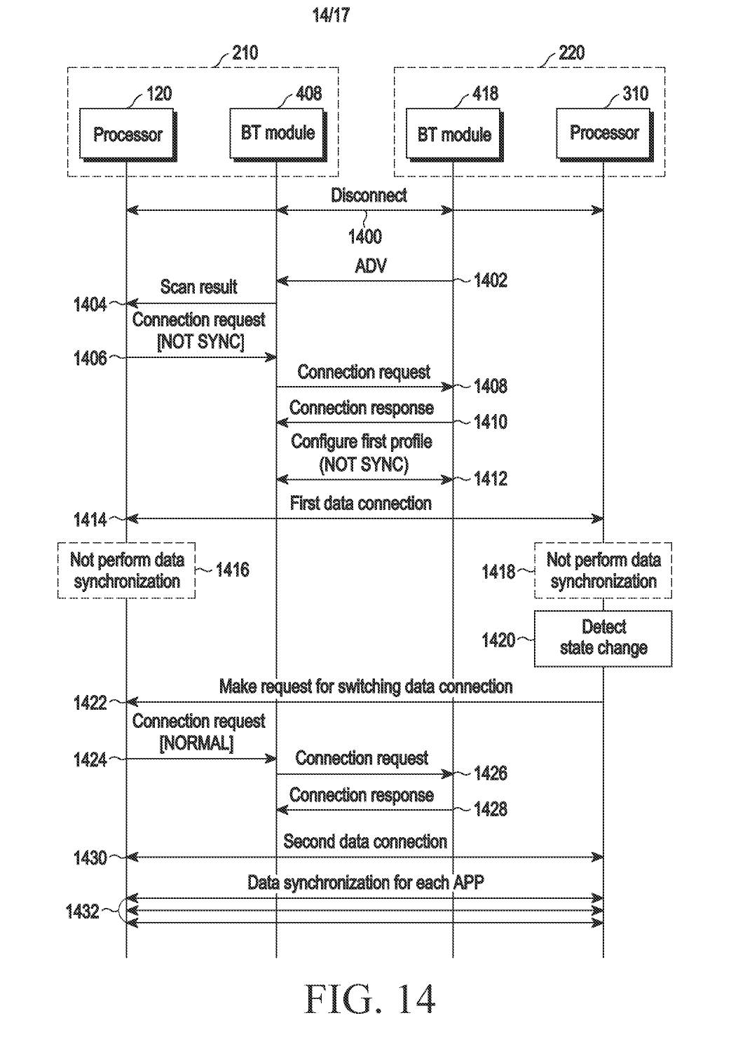

FIG. 14 is a sequence diagram illustrating a procedure of controlling a Bluetooth connection in a non-wearing state according to an embodiment of the disclosure. According to embodiments, at least one of the operations described below may be omitted or modified, or the order thereof may be changed.

Referring to FIG. 14, in operation 1400, the electronic device 210 and the 210 (for example, the Bluetooth module 408) may transmit a disconnection notification to the processor 120 and perform BLE scan for an automatic reconnection, based on a BLE scan request (not shown) being received from the processor 120.

In operation 1402, the external electronic device 220 (for example, the external electronic device 220 may disconnect the Bluetooth connection. In an embodiment, as the external electronic device 220 leaves a range (for example, the service area 510) in which Bluetooth communication with the electronic device 210 is possible, the Bluetooth connection between the electronic device 210 and the external electronic device 220 is disconnected. In an embodiment, the electronic device 210 may store information on the external electronic device 220 to be used for a reconnection with the external electronic device 220. In an embodiment, the external electronic device 220 may store information on the electronic device 210 to be used for a reconnection with the electronic device 210. In an embodiment, the electronic device processor 310) may periodically broadcast advertising data (for example, the advertising data 1002) from a time point at which the connection with the electronic device 210 is disconnected. In an embodiment, when the external electronic device 220 moves and enters the range (for example, the service area 510) in which Bluetooth communication with the electronic device 210 is possible, the electronic device 210 (for example, the Bluetooth module 408) may receive the advertising data through BLE scan (for example, background BLE scan) for the automatic reconnection.

In operation 1404, the electronic device 210 (for example, the Bluetooth module 408) may transfer the scan result related to the advertising data to the processor 120 (for example, the processor 120). In operation 1406, the electronic device 210 (for example, the processor 120) may transmit a connection request including information (for example, "NOT SYNC") making a request for the data connection (for example, the first data connection 710) that does not include data synchronization to the Bluetooth module 408, based on reception of the advertising data from the external electronic device 220 requiring the automatic reconnection being identified.

In operation 1408, the electronic device 210 (for example, the Bluetooth module 408) may transmit a connection request for the predetermined first data connection not to perform data synchronization to the external electronic device 220. In operation 1410, the external electronic device 220 (for example, the Bluetooth module 418) may transmit a connection response for the first data connection to the electronic device 210. In operation 1412, the electronic device 210 (for example, the Bluetooth module 408) and the external electronic device 220 (for example, the Bluetooth module 418) may configure a first profile defining at least one function that does not include data synchronization. In operation 1414, the electronic device 210 (for example, the processor 120) and the external electronic device 220 (for example, the processor 310) may recognize that the first data connection based on the first profile has been established. For example, the electronic device 210 (for example, the processor 120) may receive a connection notification from the Bluetooth module 408. For example, the external electronic device 220 (for example, the processor 310) may receive the connection notification from the Bluetooth module 418.

In operation 1416 and operation 1418, the electronic device 210 (for example, the processor 120) and the external electronic device 220 (for example, the processor 310) may identify that data synchronization for one or more applications related to the external electronic device 220 is not performed based on the predetermined first data connection being established not to perform data synchronization. Although not illustrated, in an embodiment, the electronic device 210 (for example, the processor 120) may perform data synchronization through the first data connection for at least one predetermined application (for example, a device search application and/or an emergency notification application) except for the applications related to the external electronic device 220. In an embodiment, the electronic device 210 (for example, the processor 120) and the external electronic device 220 (for example, the processor 310) may limit (for example, deactivate) the remaining applications except for the device search application and/or the emergency notification application during the first data connection.

In operation 1420, the external electronic device 220 (for example, the processor 310) may periodically determine the current state of the external electronic device 220 at a time point at which the first data connection with the electronic device 210 is established through the automatic reconnection and detect a state change requiring data connection switching according to the determination. In an embodiment, when the external electronic device 220 enters at least one of the wearing state, the non- charging state, the non-sleep state, or the non-low-power state, when the external electronic device 220 moves, or when a user action (for example, a wearing or touch input) through the external electronic device 220 is detected, the external electronic device 220 (for example, the processor 310) may determine that the state change is detected.

In operation 1422, the external electronic device 220 (for example, the processor 310) may transmit a data connection switching request message to the electronic device 210. In an embodiment, the data connection switching request message may be transmitted to the electronic device 210 through the first data connection. The electronic device 210 (for example, the processor 120) may determine to switch the first data connection to a data connection (for example, the second data connection 720) including data synchronization, based on the data connection switching request message being received.

In operation 1424, the electronic device 210 (for example, the processor 120) may transmit a connection request including information (for example, "NORMAL") making a request for the second data connection to the Bluetooth module 408. In operation 1426, the electronic device 210 (for example, the Bluetooth module 408) may transmit a connection request for a predetermined second data connection to the external electronic device 220 to perform data synchronization. In operation 1428, the external electronic device 220 (for example, the Bluetooth module 418) may transmit a connection response for the second data connection to the electronic device 210. Although not illustrated, in an embodiment, the electronic device 210 (for example, the Bluetooth module 408) and the external electronic device 220 (for example, the Bluetooth module 418) may configure a second profile that defines functions including data synchronization for the second data connection. In operation 1430, the electronic device 210 (for example, the processor 120) and the external electronic device 220 (for example, the processor 310) may recognize that the second data connection based on the second profile has been established. For example, the electronic device 210 (for example, the processor 120) may receive a connection notification from the Bluetooth module 408. For example, the external electronic device 220 (for example, the processor 310) may receive the connection notification from the Bluetooth module 418.

In operation 1432, the electronic device 210 (for example, the processor 120) and the external electronic device 220 (for example, the processor 310) may perform data synchronization for one or more applications through the second data connection. For example, operation 1432 may include at least one of operation 618 to operation 628.

Although not illustrated, in an embodiment, the electronic device 210 may establish the second data connection with the external electronic device 220 (for example, operation 1430), based on the advertising data being received from the external electronic device 220 requiring the automatic reconnection (for example, operation 1402). In an embodiment, the electronic device 210 may wait without performing data synchronization (for example, data synchronization in operation 1432) after the second data connection is established. At a time point at which the second data connection is established through the automatic reconnection, the external electronic device 220 may determine whether a state change is detected (for example, operation 1420) and transmit a data connection switching request message to the electronic device 210 when the state change is detected (for example, operation 1422). The electronic device 210 may perform data synchronization (for example, data synchronization in operation 1432) through the second data connection, based on the data connection switching request message being received.

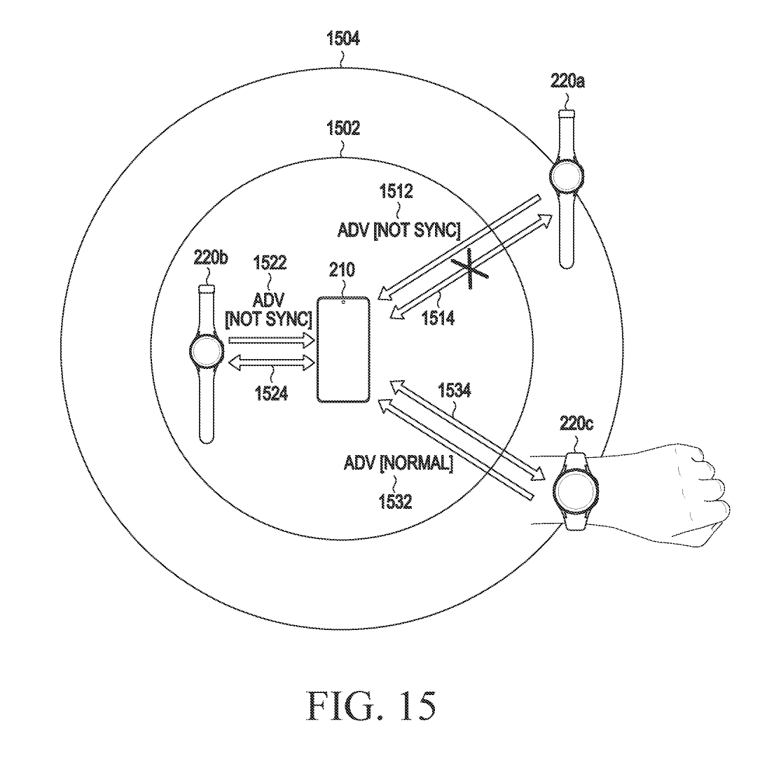

FIG. 15 is a diagram illustrating an operation of limiting a Bluetooth connection for an external electronic device in a non-wearing state according to an embodiment of the disclosure.

Referring to FIG. 15, the electronic device 210 may configure a first threshold value (for example, TH1) associated with the Bluetooth connection and a second threshold value (for example, TH2) lower than the first threshold value (TH1 > TH2). The first threshold value is associated with a first service area 1502 indicating a range closer to the electronic device 210, and the second threshold value may be associated with the second service area 1504 indicating a range farther from the electronic device 210.

After the connection with the electronic device 210 is disconnected, the external electronic device (for example, the first external electronic device 220a or the second external electronic device 220b) in a predetermined state (for example, at least one of the non-wearing state, the charging state, the sleep state, or the low-power state) may broadcast advertising data (for example, ADV[NOT SYNC] 1512 and 1522) including predetermined information (For example, the value 1018 indicating the NOT SYNC mode). On the other hand, after the connection with the electronic device 210 is disconnected, the external electronic device (for example, the third external electronic device 220c) which is not in the predetermined state (for example, at least one of the wearing state, the non-charging state, the non-sleep state, or the non-low-power state) may broadcast advertising data (for example, ADV[NORMAL] 1532) that does not include the predetermined information.

When receiving the advertising data through BLE scan, the electronic device 210 may determine whether the received advertising data includes the predetermined information (NOT SYNC). When the received advertising data includes the predetermined information, the electronic device 210 may compare the result (for example, RSSI) obtained by measuring the signal strength of the external electronic device 220 with a higher threshold value (for example, the first threshold value) and allow the Bluetooth connection only when the measurement result exceeds the first threshold value. On the other hand, when the received advertising data does not include the predetermined information, the electronic device 210 may compare the result (for example, RSSI) obtained by measuring the signal strength of the external electronic device 220 with a lower threshold value (for example, the second threshold value) and allow the Bluetooth connection when the measurement result exceeds the second threshold value.

In an embodiment, the first external electronic device 220a may broadcast ADV[NOT SYNC] 1512, based on the non-wearing state. The first external electronic device 220a is located outside the first service area 1502, and the electronic device 210 may receive ADV[NOT SYNC] 1512 and measure an RSSI (for example, a first RSSI) of the first external electronic device 220a. The electronic device 210 may compare the first RSSI of the first external electronic device 220a with the first threshold value, based on the ADV[NOT SYNC] 1512 including a value indicating the NOT SYNC mode, and may not allow a Bluetooth connection 1514 (for example, a data connection including data synchronization) with the first external electronic device 220a, based on the first RSSI not being larger than the first threshold value.

In an embodiment, the second external electronic device 220b may broadcast adv[not sync] 1522, based on the non-wearing state. The second external electronic device 220b is located within the first service area 1502, and the electronic device 210 may receive the adv[not sync] 1522 and measure an rssi (for example, a second rssi) of the second external electronic device 220b. The electronic device 210 may compare the second rssi of the second external electronic device 220b with the first threshold value, based on the adv[not sync] 1522 including a value indicating the not sync mode, and may establish a bluetooth connection 1524 (for example, a data connection including data synchronization) with the second external electronic device 220b, based on identification that the second rssi is larger than the first threshold value.

In an embodiment, the third external electronic device 220c may broadcast ADV[NORMAL] 1532, based on the wearing state. The third external electronic device 220c is located within a second service area 1504, and the electronic device 210 may receive ADV[NORMAL] 1532 and measure an RSSI (for example, a third RSSI) of the third external electronic device 220c. The electronic device 210 may compare the third RSSI of the third external electronic device 220c with the second threshold value, based on the ADV[NORMAL] 1532 not including a value indicating the NOT SYNC mode, and may establish a Bluetooth connection 1534 (for example, a data connection including data synchronization) with the third external electronic device 220c, based on the third RSSI larger than the second threshold value being identified.

In an embodiment, the first threshold value and the second threshold value may be configured based on previous Bluetooth communication between the electronic device 210 and the external electronic device (for example, the external electronic device 220a, 220b, or 220c). In an embodiment, the electronic device 210 may configure the first threshold value and the second threshold value, based on an average of the RSSI values measured for the previous connection with the external electronic device (for example, the external electronic device 220a, 220b, or 220c).

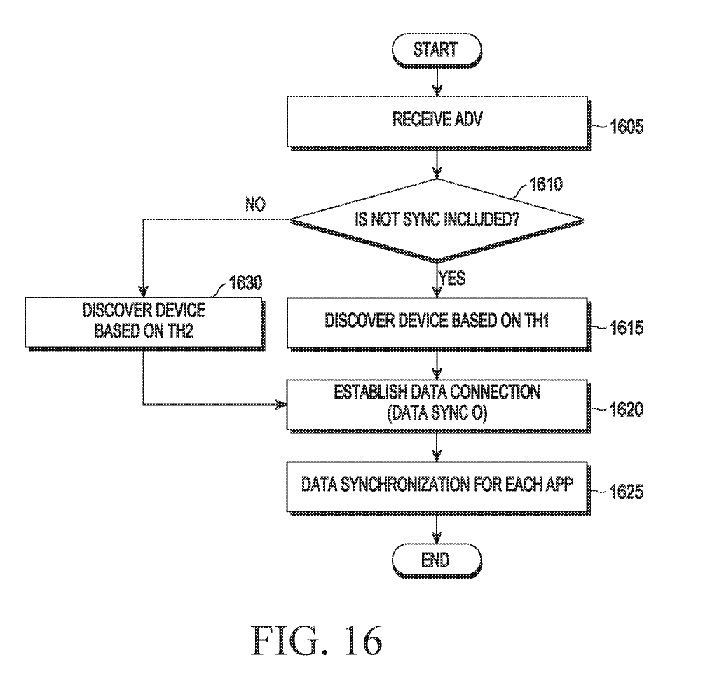

FIG. 16 is a flowchart illustrating a procedure of the electronic device controlling a Bluetooth connection, based on advertising data, according to an embodiment of the disclosure. At least one of the operations described below according to an embodiment may be performed by the processor 120 of the electronic device 210. According to embodiments, at least one of the operations described below may be omitted or modified, or the order thereof may be changed.

Referring to FIG. 16, in operation 1605, the electronic device 210 (for example, the processor 120) may receive advertising data (ADV) (for example, advertising data 1002) broadcasted by the external electronic device 220. In an embodiment, the electronic device 210 (for example, the processor 120) may identify that there is a previous connection with the external electronic device 220, based on identification information (for example, a MAC address) of the external electronic device 220 included in the advertising data and identify that the automatic reconnection with the external electronic device 220 is needed.

In operation 1610, the electronic device 210 (for example, the processor 120) may determine whether the advertising data includes predetermined information (for example, the value 1018 indicating the NOT SYNC mode). When the advertising data includes the information (NOT SYNC), the electronic device 210 (for example, the processor 120) may proceed to operation 1615. When the advertising data does not include the information (NOT SYNC), the electronic device 210 (for example, the processor 120) may proceed to operation 1630.

In operation 1615, the electronic device 210 (for example, the processor 120) may discover the external electronic device 220 by comparing an RSSI measured for the advertising data with the first threshold value. In an embodiment, the electronic device 210 (for example, the processor 120) may detect that the RSSI is larger than the first threshold value and proceed to operation 1620. Although not illustrated, when the RSSI is not larger than the first threshold value, the electronic device 210 (for example, the processor 120) may not allow the Bluetooth connection with the external electronic device 220.

In operation 1630, the electronic device 210 (for example, the processor 120) may discover the external electronic device 220 by comparing an RSSI measured for the advertising data with the second threshold value (smaller than the first threshold value). In an embodiment, the electronic device 210 (for example, the processor 120) may detect that the RSSI is larger than the second threshold value and proceed to operation 1620. Although not illustrated, when the RSSI is not larger than the second threshold value, the electronic device 210 (for example, the processor 120) may not allow the Bluetooth connection with the external electronic device 220.

In operation 1620, the electronic device 210 (for example, the processor 120) may establish the data connection (for example, the second data connection 720) including data synchronization with the external electronic device 220. In operation 1625, for applications (for example, APP#1402a, APP#2 402b, APP#3 402c, and/or the plug-in module 404) related to the external electronic device 220 included (for example, stored, installed, or executed) in the electronic device 210, the electronic device 210 (for example, the processor 120) may perform data synchronization (for example, operation 618 to operation 628) for each application through the data connection.

Although not illustrated, the electronic device 210 may proceed to operation 815, operation 820, operation 825, and operation 830 after operation 1615. In an embodiment, after discovering the external electronic device 220, based on the first threshold value in operation 1615, the electronic device 210 may establish the predetermined first data connection with the external electronic device 220 not to perform data synchronization in operation 815, and establish the second data connection with the external electronic device 220 by means of reception of the data connection switching message from the external electronic device 220 in operation 820 and perform data synchronization in operation 825 and operation 830.

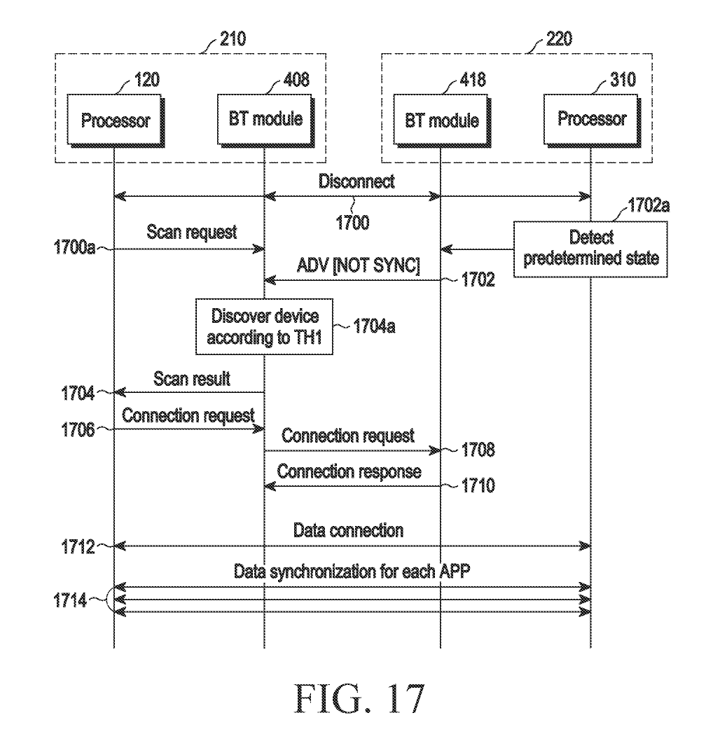

FIG. 17 illustrates a sequence diagram illustrating a procedure of controlling a Bluetooth connection, based on advertising data, according to an embodiment of the disclosure. According to embodiments, at least one of the operations described below may be omitted or modified, or the order thereof may be changed.

Referring to FIG. 17, in operation 1700, the electronic device 210 and the external electronic device 220 may disconnect the Bluetooth connection. In an embodiment, as the external electronic device 220 leaves a range (for example, the service area 510) in which Bluetooth communication with the electronic device 210 is possible, the Bluetooth connection between the electronic device 210 and the external electronic device 220 may be disconnected. In an embodiment, the electronic device 210 may store information on the external electronic device 220 to be used for a reconnection with the external electronic device 220. In an embodiment, the external electronic device 220 may store information on the electronic device 210 to be used for a reconnection with the electronic device 210. In an embodiment, the electronic device 210 (for example, the Bluetooth module 408) may transmit a disconnection notification to the processor 120.

In operation 1700a, the electronic device 210 (for example, the processor 120) may transmit a BLE scan request to the Bluetooth module 408, based on determination that the automatic reconnection with the external electronic device 220 is needed. In an embodiment, through the scan request, the electronic device 210 (for example, the processor 120) may conFIGURE(for example, activate) a first threshold value and/or a second threshold value for BLE scan to the Bluetooth module 408. The electronic device 210 (for example, the Bluetooth module 408) may perform BLE scan for the automatic reconnection, based on the first threshold value and/or the second threshold value.

In operation 1702a, the external electronic device 220 (for example, the processor 310) may periodically determine the current state of the external electronic device 220 at a time point at which the connection with the electronic device 210 is disconnected, and detect that the external electronic device 220 is in a predetermined state. In an embodiment, the external electronic device 220 (for example, the Bluetooth module 418) may transmit the disconnection notification to the processor 310, and the external electronic device 220 (for example, the processor 310) may periodically determine whether the current state of the external electronic device 220 is in a predetermined state (for example, at least one of the non-wearing state, the charging state, the sleep state, or the non-low-power state) during the disconnection, based on the disconnection notification. The external electronic device 220 (for example, the processor 310) may make a request for performing advertising including predetermined information (for example, a value indicating a NOT SYNC mode) to the Bluetooth module 418, based on the predetermined state being detected.

In operation 1702, the external electronic device 220 (for example, the Bluetooth module 418) may broadcast advertising data (for example, the advertising data 1002) including the value (for example, the value 1018) indicating the NOT SYNC mode in the manufacturer data field (for example, the manufacturer data field 1008).

In operation 1704a, the electronic device 210 (for example, the Bluetooth module 408) may receive the advertising data and compare an RSSI measured for the external electronic device 220 with the first threshold value (TH1), based on the advertising data including the value indicating the NOT SYNC mode. The electronic device 210 (for example, the processor 120) may determine that the external electronic device 220 is discovered based on the detection that the RSSI measured for the external electronic device 220 is larger than the first threshold value.

In operation 1704, the electronic device 210 (for example, the Bluetooth module 408) may transfer the scan result related to the external electronic device 220 to the processor 120. In operation 1706, the electronic device 210 (for example, the processor 120) may transmit a connection request for making a request for a data connection (for example, the predetermined second data connection 720 to perform data synchronization) to the Bluetooth module 408.

In operation 1708, the electronic device 210 (for example, the Bluetooth module 408) may transmit the connection request to the external electronic device 220. In operation 1710, the external electronic device 220 (for example, the Bluetooth module 418)may transmit a connection response to the electronic device 210. Although not illustrated, in an embodiment, the electronic device 210 (for example, the Bluetooth module 408) and the external electronic device 220 (for example, the Bluetooth module 418) may configure a profile (For example, the second profile) that defines functions including data synchronization for the data connection. In operation 1712, the electronic device 210 (for example, the processor 120) and the external electronic device 220 (for example, the processor 310) may recognize that the data connection has been established. For example, the electronic device 210 (for example, the processor 120) may receive a connection notification from the Bluetooth module 408. For example, the external electronic device 220 (for example, the processor 310) may receive the connection notification from the Bluetooth module 418.

In operation 1714, the electronic device 210 (for example, the processor 120) and the external electronic device 220 (for example, the processor 310) may perform data synchronization for one or more applications through the data connection. For example, operation may include at least one of operation 618 to operation 628.

Although not illustrated, in an embodiment, the external electronic device 220 (for example, the processor 310) may broadcast advertising data that does not include predetermined information (for example, a value indicating a NOT SYNC mode), based on detection that the external electronic device 220 is not in the predetermined state (for example, at least one of the wearing state, the non-charging state, the non-sleep state, or the non-low-power state). The electronic device 210 may identify that the advertising data does not include the value indicating the NOT SYNC mode and compare an RSSI measured for the external electronic device 220 with the second threshold value. When the RSSI is larger than the second threshold value while the external electronic device 220 moves toward the electronic device 210, the electronic device 210 may more rapidly discover the external electronic device 220 in the wearing state compared to the case where the advertising data includes the value indicating the NOT SYNC mode.

The electronic device 210 according to an embodiment may include memory 130 configured to store instructions, the wireless communication module 192, and the processor 120 functionally connected to the memory and the wireless communication module. The instructions may, when executed by the processor, cause the electronic device to receive advertising data from an external electronic device 220 through the wireless communication module. The instructions may, when executed by the processor, cause the electronic device to determine whether the advertising data includes predetermined information. The instructions may, when executed by the processor, cause the electronic device to establish a predetermined first data connection with the external electronic device through the wireless communication module not to perform a data synchronization operation, based on the advertising data including the information. The instructions may, when executed by the processor, cause the electronic device to receive a message making a request for switching a connection related to a state change of the external electronic device from the external electronic device while the first data connection is maintained. The instructions may, when executed by the processor, cause the electronic device to establish a predetermined second data connection with the external electronic device through the wireless communication module to perform the data synchronization operation, based on the connection switching request message being received. The instructions may, when executed by the processor, cause the electronic device to perform data synchronization related to one or more applications associated with the external electronic device through the second data connection.

In an embodiment, the instructions may, when executed by the processor, cause the electronic device to determine that the external electronic device is in at least one of a non-wearing state, a charging state, a sleep state, or a low-power state, based on the message being received..

In an embodiment, the predetermined information may indicate the predetermined first data connection not to perform the data synchronization operation and may be included in a manufacturer data field of the advertising data.

In an embodiment, the instructions may, when executed by the processor, cause the electronic device to identify that an automatic reconnection with the external electronic device is needed based on the advertising data being received.

In an embodiment, the instructions may, when executed by the processor, cause the electronic device to transmit a connection notification informing of establishment of the second data connection to a first application related to the external electronic device, transmit data related to the first application to the external electronic device through the second data connection, and receive the data related to the first application from the external electronic device through the second data connection.

In an embodiment, the instructions may, when executed by the processor, cause the electronic device to establish the first data connection by using a first profile defining not to perform the data synchronization operation and establish the second data connection by using a second profile defining to perform the data synchronization operation.

In an embodiment, the electronic device 210 may include the memory 130 configured to store instructions, the wireless communication module 192 configured to support Bluetooth communication, and the processor 120 functionally connected to the memory and the wireless communication module. The instructions may, when executed by the processor, cause the electronic device to receive advertising data from an external electronic device 220 through the wireless communication module. The instructions may, when executed by the processor, cause the electronic device to establish a predetermined first data connection with the external electronic device through the wireless communication module not to perform a data synchronization operation, based on the advertising data being received. The instructions may, when executed by the processor, cause the electronic device to receive a message making a request for switching a connection related to a state change of the external electronic device from the external electronic device while the first data connection is maintained. The instructions may, when executed by the processor, cause the electronic device to establish a predetermined second data connection with the external electronic device through the wireless communication module to perform the data synchronization operation, based on the message being received. The instructions may, when executed by the processor, cause the electronic device to perform data synchronization related to one or more applications associated with the external electronic device through the second data connection.

In an embodiment, the instructions may, when executed by the processor, cause the electronic device to identify that an automatic reconnection with the external electronic device is needed based on the advertising data being received.

In an embodiment, the instructions may, when executed by the processor, cause the electronic device to transmit a connection notification informing of establishment of the second data connection to a first application related to the external electronic device, transmit data related to the first application to the external electronic device through the second data connection, and receive the data related to the first application from the external electronic device through the second data connection.

In an embodiment, the instructions may, when executed by the processor, cause the electronic device to establish the first data connection by using a first profile defining not to perform the data synchronization operation and establish the second data connection by using a second profile defining to perform the data synchronization operation.

In an embodiment, the electronic device 210 may include the memory 130 configured to store instructions, the wireless communication module 192 configured to support Bluetooth communication, and the processor 120 functionally connected to the memory and the wireless communication module. The instructions may, when executed by the processor, cause the electronic device to receive advertising data from an external electronic device 220 through the wireless communication module. The instructions may, when executed by the processor, cause the electronic device to determine whether the advertising data includes predetermined information. The instructions may, when executed by the processor, cause the electronic device to determine whether a first received signal strength measured for the external electronic device exceed a first threshold value, based on identification that the advertising data includes the predetermined information. The instructions may, when executed by the processor, cause the electronic device to determine that the external electronic device is discovered when the first received signal strength exceeds the first threshold value. The instructions may, when executed by the processor, cause the electronic device to determine whether a second received signal strength measured for the external electronic device exceeds a second threshold value smaller than the first threshold value, based on identification that the advertising data does not include the information. The instructions may, when executed by the processor, cause the electronic device to determine that the external electronic device is discovered when the second received signal strength exceeds the second threshold value.

In an embodiment, the instructions may, when executed by the processor, cause the electronic device to determine that the external electronic device is in at least one of a non-wearing state, a charging state, a sleep state, or a low-power state, based on the advertising data including the information being received when the external electronic device is a wearable device.

In an embodiment, the predetermined information may indicate a predetermined first data connection not to perform the data synchronization operation and may be included in a manufacturer data field of the advertising data.

In an embodiment, the instructions may, when executed by the processor, cause the electronic device to identify that an automatic reconnection with the external electronic device is needed based on the advertising data being received.

In an embodiment, the instructions may, when executed by the processor, cause the electronic device to transmit a connection notification informing of establishment of the second data connection to a first application related to the external electronic device, transmit data related to the first application to the external electronic device through the second data connection, and receive the data related to the first application from the external electronic device through the second data connection.

In an embodiment, the instructions may, when executed by the processor, cause the electronic device to establish the first data connection by using a first profile defining not to perform the data synchronization operation and establish the second data connection by using a second profile defining to perform the data synchronization operation.

The electronic device 220 configured to control a Bluetooth connection according to an embodiment may include the memory 350 configured to store instructions, the sensor module 330, the communication circuit 320, and the processor 310 functionally connected to the memory, the sensor module, and the communication circuit. The instructions may, when executed by the processor, cause the electronic device to determine whether the electronic device is in a predetermined state through the sensor module. The instructions may, when executed by the processor, cause the electronic device to broadcast advertising data including predetermined information when the electronic device is in the predetermined state. The instructions may, when executed by the processor, cause the electronic device to establish a predetermined first data connection with an external electronic device 210 receiving the advertising data not to perform a data synchronization operation through the communication circuit. The instructions may, when executed by the processor, cause the electronic device to detect a state change of the electronic device while the first data connection is maintained. The instructions may, when executed by the processor, cause the electronic device to transmit a message making a request for switching a connection to the external electronic device, based on the state change being detected. The instructions may, when executed by the processor, cause the electronic device to establish a predetermined second data connection with the external electronic device through the communication circuit to perform the data synchronization operation, based on the connection switching request message being transmitted. The instructions may, when executed by the processor, cause the electronic device to perform data synchronization related to one or more applications associated with the external electronic device through the second data connection.

In an embodiment, the predetermined state may include at least one of a non-wearing state of the electronic device, a charging state, a sleep state, or a low-power state.

In an embodiment, the instructions may, when executed by the processor, cause the electronic device to determine that the state change is detected when the electronic device escapes the predetermined state.

The electronic device 220 configured to control a Bluetooth connection according to an embodiment may include the memory 350 configured to store instructions, the sensor module 330, communication circuit 320 configured to support Bluetooth communication, and the processor 310 functionally connected to the memory, the sensor module, and the communication circuit. The instructions may, when executed by the processor, cause the electronic device to broadcast advertising data through the communication circuit. The instructions may, when executed by the processor, cause the electronic device to establish a predetermined first data connection with an external electronic device 210 receiving the advertising data not to perform a data synchronization operation through the communication circuit. The instructions may, when executed by the processor, cause the electronic device to detect a state change of the electronic device while the first data connection is maintained. The instructions may, when executed by the processor, cause the electronic device to transmit a message making a request for switching a connection to the external electronic device, based on the state change being detected. The instructions may, when executed by the processor, cause the electronic device to establish a predetermined second data connection with the external electronic device through the communication circuit to perform the data synchronization operation, based on the message being transmitted. The instructions may, when executed by the processor, cause the electronic device to perform data synchronization related to one or more applications associated with the external electronic device through the second data connection.

A method of operating the electronic device 210 configured to control a Bluetooth connection according to an embodiment may include operation 805 of receiving advertising data from an external electronic device. The method may include operation 810 of determining whether the advertising data includes predetermined information. The method may include operation 815 of establishing a predetermined first data connection with the external electronic device not to perform a data synchronization operation, based on the advertising data including the information. The method may include operation 820 of receiving a connection switching request message related to a state change of the external electronic device from the external electronic device while the first data connection is maintained. The method may include operation 825 of establishing a predetermined second data connection with the external electronic device to perform the data synchronization operation, based on the connection switching request message being received. The method may include operation 830 of performing data synchronization related to one or more applications associated with the external electronic device through the second data connection.

In an embodiment, the method may include an operation of determining that the external electronic device is in at least one of a non-wearing state, a charging state, a sleep state, or a low-power state, based on the connection switching request message being received.

In an embodiment, the advertising data may include the information indicating the predetermined first data connection not to perform the data synchronization operation within a manufacturer data field.

In an embodiment, the method may further include an operation of identifying that an automatic reconnection with the external electronic device is needed based on the advertising data being received.

In an embodiment, the operation of performing the data synchronization may include an operation of transmitting a connection notification informing of establishment of the second data connection to a first application related to the external electronic device, an operation of transmitting data related to the first application to the external electronic device through the second data connection, and an operation of receiving the data related to the first application from the external electronic device through the second data connection.

In an embodiment, the first data connection may be established using a first profile defining not to perform the data synchronization operation, and the second data connection may be established using a second profile defining to perform the data synchronization operation.

In an embodiment, the method may include operation 1615 of determining a first received signal strength measured for the external electronic device exceeds a first threshold value, based on identification that the advertising data includes the information, operation of determining that the external electronic device is discovered when the first received signal strength exceeds the first threshold value, operation 1630 of determining whether a second received signal strength measured for the external electronic device exceeds a second threshold value smaller than the first threshold value, based on identification that the advertising data does not include the information, and an operation of determining that the external electronic device is discovered when the second received signal strength exceeds the second threshold value.

The method of the electronic device 220 configured to control the Bluetooth connection according to an embodiment may include operation 905 of determining whether the electronic device is in a predetermined state through the sensor module. The method may include operation 910 of transmitting advertising data including predetermined information when the electronic device is in the predetermined state. The method may include operation 915 of establishing a predetermined first data connection with the external electronic device 210 receiving the advertising data not to perform a data synchronization operation. The method may include operation 920 of detecting a state change of the electronic device while the first data connection is maintained. The method may include operation 925 of transmitting a connection switching request message to the external electronic device, based on the state change being detected. The method may include operation 930 of establishing a predetermined second data connection with the external electronic device to perform the data synchronization operation, based on the connection switching request message being transmitted. The method may include operation 935 of performing data synchronization related to one or more applications associated with the external electronic device through the second data connection.

In an embodiment, the predetermined state may include at least one of a non-wearing state of the electronic device, a charging state, a sleep state, or a low-power state when the electronic device is a wearable device.

In an embodiment, the operation of detecting the state change may include an operation of determining that the state change is detected when the electronic device escapes the predetermined state.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., memory 390, internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions;
wireless communication circuitry configured to support Bluetooth (BT) communication; and
one or more processors communicatively coupled to the memory and the wireless communication circuitry,
wherein the instructions, when executed by the one or more processors individually or collectively, cause the electronic device to: receive advertising data from an external electronic device through the wireless communication circuitry, determine whether the advertising data comprises predetermined information, based on the advertising data comprising the predetermined information,
establish a first data connection with the external electronic device through the wireless communication circuitry, the first data connection being designated not to perform a data synchronization operation, receive a message requesting connection switching related to a state change of the external electronic device from the external electronic device while the first data connection is maintained, based on the reception of the message, establish a second data connection with the external electronic device through the wireless communication circuitry, the second data connection being designated to perform a data synchronization operation, and perform data synchronization related to one or more applications associated with the external electronic device through the second data connection.

2. The electronic device of claim 1, wherein the instructions, when executed by the one or more processors individually or collectively, further cause the electronic device to, in case that the external electronic device is a wearable device,
determine that the external electronic device is in at least one of a non-wearing state, a charging state, a sleep state, or a low-power state, based on the reception of the message.

3. The electronic device of claim 1, wherein the predetermined information indicates the first data connection designated not to perform a data synchronization operation, and is included in a manufacturer data field of the advertising data.

4. The electronic device of claim 1, wherein the instructions, when executed by the one or more processors individually or collectively, further cause the electronic device to, based on the reception of the advertising data, identify that an automatic reconnection with the external electronic device is needed.

5. The electronic device of claim 1, wherein the instructions, when executed by the one or more processors individually or collectively, further cause the electronic device to:
transmit, to a first application related to the external electronic device, a connection notification informing of establishment of the second data connection;
transmit data related to the first application to the external electronic device through the second data connection; and
receive data related to the first application from the external electronic device through the second data connection.

6. The electronic device of claim 1, wherein the instructions, when executed by the one or more processors individually or collectively, further cause the electronic device to:
establish the first data connection by using a first profile defining not to perform a data synchronization operation; and
establish the second data connection by using a second profile defining to perform a data synchronization operation.

7. An electronic device comprising:
memory, comprising one or more storage media, storing instructions;
wireless communication circuitry configured to support Bluetooth (BT) communication; and
one or more processors communicatively coupled to the memory and the wireless communication circuitry,
wherein the instructions, when executed by the one or more processors individually or collectively, cause the electronic device to: receive advertising data from an external electronic device through the wireless communication circuitry, based on the reception of the advertising data, establish a first data connection with the external electronic device through the wireless communication circuitry, the first data connection being designated not to perform a data synchronization operation, receive a message requesting connection switching related to a state change of the external electronic device from the external electronic device while the first data connection is maintained, based on the reception of the message, establish a second data connection with the external electronic device through the wireless communication circuitry, the second data connection being designated to perform a data synchronization operation, and perform data synchronization related to one or more applications associated with the external electronic device through the second data connection.

8. The electronic device of claim 7, wherein the instructions, when executed by the one or more processors individually or collectively, further cause the electronic device to, based on receiving the advertising data, identify that an automatic reconnection with the external electronic device is needed.

9. The electronic device of claim 7, wherein the instructions, when executed by the one or more processors individually or collectively, further cause the electronic device to:
transmit, to a first application related to the external electronic device, a connection notification informing of establishment of the second data connection;
transmit data related to the first application to the external electronic device through the second data connection; and
receive data related to the first application from the external electronic device through the second data connection.

10. The electronic device of claim 7, wherein the instructions, when executed by the one or more processors individually or collectively, further cause the electronic device to:
establish the first data connection by using a first profile defining not to perform a data synchronization operation; and
establish the second data connection by using a second profile defining to perform a data synchronization operation.

11. The electronic device of claim 7, wherein the instructions, when executed by the one or more processors individually or collectively, further cause the electronic device to, in case that the external electronic device is a wearable device, determine that the external electronic device is in at least one of a non-wearing state, a charging state, a sleep state, or a low-power state, based on the reception of the message.

12. The electronic device of claim 7 wherein the instructions, when executed by the one or more processors individually or collectively, further cause the electronic device to:
determine whether the advertising data comprises predetermined information,
wherein the predetermined information indicates the first data connection designated not to perform a data synchronization operation, and is included in a manufacturer data field of the advertising data.

13. An electronic device comprising:
memory, comprising one or more storage media, storing instructions;
wireless communication circuitry configured to support Bluetooth (BT) communication; and
one or more processors communicatively coupled to the memory and the wireless communication circuitry,
wherein the instructions, when executed by the one or more processors individually or collectively, cause the electronic device to: receive advertising data from an external electronic device through the wireless communication circuitry, determine whether the advertising data comprises predetermined information, based on identifying that the advertising data comprises the predetermined information, determine whether a first received signal strength measured for the external electronic device exceeds a first threshold value, in case that the first received signal strength exceeds the first threshold value, determine that the external electronic device is discovered, based on identifying that the advertising data does not comprise the predetermined information, determine whether a second received signal strength measured for the external electronic device exceeds a second threshold value smaller than the first threshold value, and in case that the second received signal strength exceeds the second threshold value, determine that the external electronic device is discovered.

14. The electronic device of claim 13 wherein the instructions, when executed by the one or more processors individually or collectively, further cause the electronic device to, in case that the external electronic device is a wearable device, determine that the external electronic device is in at least one of a non-wearing state, a charging state, a sleep state, or a low- power state, based on the reception of the advertising data comprising the predetermined information, and
wherein the predetermined information indicates a first data connection designated not to perform a data synchronization operation, and is included in a manufacturer data field of the advertising data.

15. The electronic device of claim 13, wherein the instructions, when executed by the one or more processors individually or collectively, further cause the electronic device to:
based on receiving the advertising data, identify that an automatic reconnection with the external electronic device is needed.

16. The electronic device of claim 13, wherein the instructions, when executed by the one or more processors individually or collectively, further cause the electronic device to:
transmit, to a first application related to the external electronic device, a connection notification informing of establishment of a second data connection;
transmit data related to the first application to the external electronic device through the second data connection; and
receive the data related to the first application from the external electronic device through the second data connection.

17. The electronic device of claim 13, wherein the instructions, when executed by the one or more processors individually or collectively, further cause the electronic device to:
establish a first data connection by using a first profile defining not to perform a data synchronization operation; and
establish a second data connection by using a second profile defining to perform a data synchronization operation.

18. The electronic device of claim 13, wherein the instructions, when executed by the one or more processors individually or collectively, further cause the electronic device to:
based on receiving the advertising data, identify that an automatic reconnection with the external electronic device is needed;
transmit, to a first application related to the external electronic device, a connection notification informing of establishment of a second data connection;
transmit data related to the first application to the external electronic device through the second data connection;
receive the data related to the first application from the external electronic device through the second data connection;
establish a first data connection by using a first profile defining not to perform a data synchronization operation; and
establish a second data connection by using a second profile defining to perform a data synchronization operation.

19. An electronic device for controlling a Bluetooth (BT) connection, the electronic device comprising:
memory, comprising one or more storage media, storing instructions;
a sensor module;
communication circuitry configured to support Bluetooth communication; and
one or more processors communicatively coupled to the memory, the sensor module, and the communication circuitry,
wherein the instructions, when executed by the one or more processors individually or collectively, cause the electronic device to:
determine, through the sensor module, whether the electronic device is in a predetermined state,
in case that the electronic device is in the predetermined state, broadcast advertising data comprising predetermined information,
establish a first data connection with an external electronic device receiving the advertising data through the communication circuitry, the first data connection being designated not to perform a data synchronization operation,
detect a state change of the electronic device while the first data connection is maintained,
based on detecting the state change, transmit a message requesting connection switching to the external electronic device,
based on the transmission of the message, establish a second data connection with the external electronic device through the communication circuitry, the second data connection being designated to perform a data synchronization operation, and
perform data synchronization related to one or more applications associated with the external electronic device through the second data connection.

20. An electronic device for controlling a Bluetooth (BT) connection, the electronic device comprising:
memory, comprising one or more storage media, storing instructions;
a sensor module;
communication circuitry configured to support Bluetooth communication; and
one or more processors communicatively coupled to the memory, the sensor module, and the communication circuitry,
wherein the instructions, when executed by the one or more processors individually or collectively, cause the electronic device to: broadcast advertising data through the communication circuitry,
establish a first data connection with an external electronic device receiving the advertising data through the communication circuitry, the first data connection being designated not to perform a data synchronization operation,
detect a state change of the electronic device while the first data connection is maintained,
based on detecting the state change, transmit a message requesting connection switching to the external electronic device,
based on the transmission of the message, establish a second data connection with the external electronic device through the communication circuitry, the second data connection being designated to perform a data synchronization operation, and
perform data synchronization related to one or more applications associated with the external electronic device through the second data connection.
